(19) United States
(12) Patent Application Publication
(10) Pub. No.: US 2025/0204530 A1
(43) Pub. Date: Jun. 26, 2025

(54) USE OF CAROTENIOD COMPOSITION FOR NEMATODE CONTROL

(71) Applicant: IDAI NATURE, S.L., Valencia (ES)

(72) Inventors: Teresa YUSTE CERVERA, Valencia (ES); José Luís GARCÍA QUILIS, Valencia (ES); Sergio LLUECA TRONCH, Valencia (ES); Ignacio DE ALFONSO MARZAL, Valencia (ES)

(21) Appl. No.: 18/869,621

(22) PCT Filed: Jun. 1, 2023
(86) PCT No.: PCT/IB2023/055660

§ 371 Date: Nov. 26, 2024

(30) Foreign Application Priority Data
Jun. 1, 2022 (EP) 22382533.2

(51) Int. Cl. A01N 49/00; A01N 25/04; A01N 25/22; A01P 5/00

(52) U.S. Cl. CPC A01N 49/00; A01N 25/04; A01N 25/22; A01P 5/00

(57) ABSTRACT

A composition which includes one or more carotenoids, and use of the composition for nematode control.

The invention relates to the use of a composition which comprises one or more carotenoids for nematode control. The invention further extends to the compositions themselves.

### BACKGROUND ART

Plant-parasitic nematodes are microscopic, transparent animals and are characterised by the presence of the stylet, a lance-shaped structure located in the anterior region of the body with which they pierce plant cells and suck the contents out of them. The distribution of nematodes in the soil is irregular, forming aggregates or foci, and their main dispersal mechanism is passive with the movement of soil, machinery, tools or infected plant material, although they can also move by their own movement. The main factors favouring the development of the disease are the population levels of the nematode at the beginning of the crop, the susceptibility of the crop, and the soil temperature.

Meloidogyne species are the main nematological problem in horticultural crops with M. incognita and M. javanica being the most common species followed by M. arenaria. These nematodes cause root galls, a distinctive symptom of Meloidogyne parasitism that has diagnostic value for the genus. In contrast, the symptoms produced by plant-parasitic nematodes on the aerial part of a plant are non-specific and like those caused by other soil diseases or nutritional deficiencies. These symptoms are manifested by stunted initial growth, ascending chlorosis, reduced vigour, reduced fruit set and fruit size, and early senescence. These symptoms often go unnoticed or are attributed to other pests or diseases, or to crop problems (fertilisation, salinity, etc.), so that when they are detected, the population levels are very high, and the damage is irremediable.

Of all the important plant-parasitic nematodes, the most successful species are the sedentary groups which establish a permanent feeding site within the plant host and obtain nutrients while completing their lifecycles. Sedentary nematodes have a natural advantage over their migratory relatives due to a fascinating and complex method of host cell transformation resulting in the development a sustainable feeding structure. According to the American Society of Phytopathology (APS), it is estimated that economic losses in the agricultural sector due to nematodes represent 14% of the worldwide crop yield losses, which is almost 125 billion dollars annually, the major genera of phytoparasitic nematodes reported to cause crop losses were Heterodera, Globodera, Meloidogyne, Radopholus, Pratylenchus, Tylenchulus, Telotylenchus, Tylenchorhynchus, Helycotylenchus Longidorus, Trichodorus, Xiphinema, Ditylenchus, Aphelenchoides and Anguina combat (Concepción M. Mesa-Valle, Jose A. Garrido-Cardenas, Jose Cebrian-Carmona, Miguel Talavera and Francisco Manzano-Agugliaro, Agronomy 2020, 10, 1148).

Plant-parasitic nematodes are generally controlled using synthetic chemical nematicides, nematistatics, crop rotations, thermal treatments, and engineering of resistant cultivars. However, chemical nematicide and/or nematistatic use is becoming increasingly limited due to potential environmental problems and human and animal health concerns. For example, effective nematicides such as DBCP (1,2-dibromo-3-chloropropane) and ethylene dibromide (1,2-dibromoethane) have been withdrawn from the market due to their possible deleterious effects on humans and the environment. The highly toxic aldicarb (2-Methyl-2-(methylthio)propanal O—(N-methylcarbamoyl) oxime), which is used to control insects and nematodes, has been detected in groundwater. High levels of 1,3-D (1,3-dichloroprop-1-ene), the last generalised soil fumigant, has been detected in the air of California, where this nematicide is used intensively. Methyl bromide (bromomethane), the most effective and widely used fumigant for controlling soil-borne diseases, nematodes, and weeds, has already been banned in some countries, and its complete withdrawal from the market is planned for most countries by international agreements due to its destructive potential to stratospheric ozone.

In addition, the increasing incidence of nematicide resistance is also fuelling the need for new nematicides and/or nematistatics and/or nematode control agents. As an alternative to chemical nematicides and nematistatics, the use of natural products for the control of plant pathogens and/or pests may be very promising (Fawzia H. Abdel-Rahman, Nina M. Alaniz & Mahmoud A. Saleh, Journal of Environmental Science and Health, 2012, 48, 16).

Active ingredient compounds extracted from natural sources are the preferred safe option replacing traditional chemical pesticides, but the stability of these compounds outside the plants, flowers or fruits is reduced by oxidation by air or water, compromised by UV-light, and compromised by pH changes in the environment. In particular, carotenoids in general have an unstable tendency against environmental factor, i.e. light irradiation, temperature and oxidation (Kurniawan J. M. et al, 13^{th} Joint Conference on Chemistry, IOP Conference Series: Materials Sciences and Engineering, vol. 509, 3 May 2019, page 012060), and because of these stability problems it is a challenging task to develop natural compounds containing carotenoids in a stable formulation for use in agrochemical applications.

US 2008/0220038A1 describes a method for killing and controlling nematodes applying a mixture of selected terpenes in an effective amount inside very high purity hollow glucan particles. Preferred terpenes components are 100% citral, 50% citral and 50% b-ionone, 50% citral and 50% a-terpineol, 50% d-limonene and 50% b-ionone, or 50% a-terpineol and 50% b-ionone.

It is known that plant extracts of some species have nematostactic and/or nematicidal effects, e.g., G. mexicanum, A. integrifolium, A. aurantium, A. subsviscida, H. terebinthinaceus, and some compounds that have these properties are also known and discussed in the prior art, e.g., stigmasterol, β-sistosterol, α-terthienyl, allantoin, α-ecdysone (Velasco-Azorsa et al., Molecules, Characterization of plant extracts and evaluation of their nematicidal and phytotoxic potential, vol 26, no. 8, 12 Apr. 2021, page 2216).

WO 2007/132224A2 describes the combined use of natural essential oils from three selected species of having a nematicidal effect, Tagetes erecta oil, Ocimum basilicum (sweet basil) oil or a Cymbopogon martini (palmerosa) oil. Also describes the compounds present in each oil and in particular the oil of Tagetes erecta.

Priyanka Dixit et al. describes the component α-tertheinyl as the compound responsible for nematicidal activities of the marigold (Tagetes species) and suggests that only the live plants can promote the nematicidal activities of α-tertheinyl—“Research has shown that the nematicidal compound (alpha-tertheinyl) is only released by active, living Tagetes roots, because exposure to near-UV light inactivates alpha-tertheinyl when taken out of the soil. Thus there is no benefit in amending a planting site with tagetes extracts of homogenized plant parts.” (Priyanaka Dixit et al., International Research Journal of Pharmacy a brief study on marigold (tagetes species): a review, 1^{st} January 2013).

In particular, carotenoids in general have an unstable tendency against environmental factor, i.e. light irradiation, temperature and oxidation (Kurniawan J. M. et al., 13^{th} Joint Conference on Chemistry, IOP Conference Series: Materials Sciences and Engineering, vol. 509, 3 May 2019, page 012060). Kurniawan suggests that the drying treatment is necessary during the industrial process of encapsulation of lutein esther and also suggests that encapsulation process may increase the solubility of carotenoids and widen its application in food or nutraceutical products.

Carotenoids are specially very susceptible to degradation when formulated and there is a continued need for delivery systems allow formulation of carotenoids for nematode control without using encapsulation processes. There is also a need for providing carotenoid containing formulations that are stable over time, across different temperatures, and in use. Since carotenoids are known to degrade readily there is also a need to provide a formulation that could provide synergy and/or enhance the efficacy of carotenoids as a component of an agrochemical formulation.

Accordingly, it would be desirable to have a composition for nematode control that does not present the above indicated toxicity problems and/or stability problems and maintains its efficacy against nematodes.

### SUMMARY OF THE INVENTION

A first aspect of the present invention relates to the use of a composition which comprises one or more carotenoids for nematode control.

In another embodiment, the invention relates to the use of the composition as defined above, wherein the carotenoids are selected from lutein, beta-carotene, astaxanthin, lycopene, zeaxanthin and apocarotenal.

In another embodiment, the invention relates to the use of the composition as defined anywhere above, which further comprises a dispersant, preferably wherein the dispersant is selected from, but not limited to, the group comprising: (C₂-C₁₂) alcohols, ethanol, isopropanol, n-octanol, 2 ethyl-hexanol, glycerin, glycerol, (C₂-C₃₀) alkene glycol, dipropylene glycol, polypropylene glycol, butyl glycol or alkyl ethers thereof, sorbitol, mannitol, dulcitol, ethyl lactate, butyl lactate, 2-ethylhexyl lactate, and/or combinations or derivatives thereof. More preferably wherein the dispersant is butyl glycol.

In another embodiment, the invention relates to the use of the composition as defined anywhere above, wherein the carotenoids are dispersed in a carrier, preferably wherein the carrier is a vegetable oil, more preferably wherein the vegetable oil is selected from, but not limited to, the group comprising: sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil, and glycerine vegetable ester oils. Even more preferably wherein the vegetable oil is selected from, but not limited to, the group comprising: sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester and glycerol oil. And still more preferably wherein the vegetable oil is sunflower oil.

In another embodiment, the invention relates to the use of the composition as defined anywhere above, which further comprises one or more tensioactives, including nonionic and anionic tensioactives. Nonionic tensioactive may include alkoxylated sorbitan fatty esters, ethoxylated sorbitan fatty esters, ethoxylated sorbitol fatty esters, polysorbate E20, polysorbate E80, polysorbate E85, ethoxylated fatty acids, ethoxylated fatty alcohols, ethoxylated and propoxylated fatty acids, ethoxylated and propoxylated fatty alcohols, lecithin, graft acrylic copolymers, alkyl polyglucosides, and/or combinations thereof. Anionic tensioactives may include alkyl benzene sulfonic acid salts, alkyl ether sulfates, alkyl ethoxylated ether sulfates, alkyl polyglycol ether phosphates, alkyl phosphate esters, lignosulfonates, naphthalene sulfonates, ethoxylated tristyrylphenol phosphates, random acrylic copolymers, and/or combinations thereof. Preferably the composition comprises three tensioactives polysorbate E20, polysorbate E80 and polysorbate E85.

In another embodiment, the invention relates to the use of the composition as defined anywhere above, which may further comprise an additive selected from, but not limited to, the group comprising: preservatives, humectant, wetting agents, spreaders, compatibilizers, binders, fillers, adhesives, protective colloids, thickeners, thixotropic agents, penetrants, retention promoters, sequestrants, clarifiers, anti-freezing agents, anti-caking agents, hydrotropes, stabilizers, antioxidants, UV-light protectors, acidifiers, alkaline agents, chelates, complexing agents, dyes, rheology modifiers, antifoams, anti-drift agents, and/or combinations thereof. Preferably the composition comprises at least an antioxidant or an UV-light protector, such as butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and/or combinations thereof.

In another embodiment, the invention relates to the use of the composition as defined anywhere above, which may further comprise an antioxidant or an UV-light protector, preferably wherein the antioxidant or UV-light protector is selected from butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and/or combinations thereof, further preferably wherein the antioxidant is terc-butyl hydroquinone (TBHQ) and/or tocopherol and/or propyl galate.

In another embodiment, the invention relates to the use of the composition as defined anywhere above, wherein the nematode is of the genus Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans.

In another embodiment, the invention relates to the use of the composition as defined anywhere above for nematode control, wherein:
the nematode is of the genus Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans;
the carotenoid being selected from lutein, beta-carotene, astaxanthin, lycopene, zeaxanthin and apocarotenal; and
the carrier is a vegetable oil, more preferably wherein the vegetable oil is selected from sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester glycerol oil and glycerine vegetable ester oils, even more preferably wherein the vegetable oil is selected from sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, and glycerol oil, and still more preferably wherein the vegetable oil is sunflower oil;
and wherein the composition further comprises:
one or more tensioactives, and preferably comprises three tensioactives polysorbate E20, polysorbate E80 and polysorbate E85; and
a dispersant, preferably wherein the dispersant is selected from ethanol, isopropanol, glycerol, propylene glycol, butyl glycol, dipropylene glycol and sorbitol, and more preferably wherein the dispersant is butyl glycol.

The use of the composition, wherein the composition further comprises an antioxidant or an UV-light protector, preferably wherein the antioxidant or UV-light protector is selected from butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and/or combinations thereof, further preferably wherein the antioxidant is terc-butyl hydroquinone (TBHQ) and/or tocopherol and/or propyl galate.

In another embodiment, the invention relates to the use of the composition as defined anywhere above for nematode control, wherein the nematode is of the Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
a carotenoid selected from beta-carotene dispersed in sunflower oil, astaxanthin dispersed in sunflower oil, lutein dispersed in sunflower oil, lycopene dispersed in sunflower oil, zeaxanthin dispersed in sunflower oil, and/or apocarotenal dispersed in sunflower oil;
three tensioactives polysorbate E20, polysorbate E80 and polysorbate E85;
the dispersant butyl glycol; and
the antioxidant or UV-light protector terc-butyl hydroquinone (TBHQ) and/or tocopherol and/or propyl galate.

In another embodiment the invention relates to the use of the composition as defined anywhere above for nematode control, preferably wherein the nematode is of the genus Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
a carotenoid selected from beta-carotene dispersed in sunflower oil, astaxantin dispersed in sunflower oil, lutein dispersed in sunflower oil, lycopene dispersed in sunflower oil, zeaxanthin dispersed in sunflower oil, and/or apocarotenal dispersed in sunflower oil;
three tensioactives polysorbate E20, polysorbate E80 and polysorbate E85;
the dispersant butyl glycol; and
the antioxidant TBHQ.
wherein:
the sunflower oil is from 2% to 10% (w/w of total composition);
the carotenoid is from 0.1% to 15% (w/w of total composition);
the tensioactives are from 20% to 50% (w/w of total composition);
the dispersant is from 2% to 10% (w/w of total composition); and the antioxidant is from 0.05% to 5% (w/w of total composition).

In another embodiment, the invention relates to the use of the composition as defined anywhere above for nematode control, wherein the composition may additionally include water from is from 0.1% to 60% (w/w of total composition).

In another embodiment, the invention relates to the use of the composition as defined anywhere above for nematode control, preferably wherein the nematode is of the genus Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
beta-carotene (1.5% w/w of total composition) dispersed in sunflower oil (6% w/w of total composition);
three tensioactives polysorbate E20 (15% w/w of total composition), polysorbate E80 (15% w/w of total composition) and polysorbate E85 (15% w/w of total composition);
the dispersant butyl glycol (5% w/w of total composition);
the antioxidant TBHQ (0.7% w/w of total composition); and
water (41.8% w/w of total composition).

In another embodiment, the invention relates to the use of the composition as defined anywhere above for nematode control, preferably wherein the nematode is of the genus Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
astaxanthin (1.5% w/w of total composition) dispersed in sunflower oil (6% w/w of total composition);
three tensioactives polysorbate E20 (15% w/w of total composition), polysorbate E80 (15% w/w of total composition) and polysorbate E85 (15% w/w of total composition);
the dispersant butyl glycol (5% w/w of total composition);
the antioxidant TBHQ (0.7% w/w of total composition); and
water (41.8% w/w of total composition).

In another embodiment, the invention relates to the use of the composition as defined anywhere above for nematode control, wherein the nematode is of the Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
lutein (1.5% w/w of total composition) dispersed in sunflower oil (6% w/w of total composition);
three tensioactives polysorbate E20 (15% w/w of total composition), polysorbate E80 (15% w/w of total composition) and polysorbate E85 (15% w/w of total composition);
the dispersant butyl glycol (5% w/w of total composition);
the antioxidant TBHQ (0.7% w/w of total composition); and
water (41.8% w/w of total composition).

In another embodiment, the invention relates to the use of the composition as defined anywhere above for nematode control, wherein the nematode is of the Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
lycopene (1.5% w/w of total composition) dispersed in sunflower oil (6% w/w of total composition);
three tensioactives polysorbate E20 (15% w/w of total composition), polysorbate E80 (15% w/w of total composition) and polysorbate E85 (15% w/w of total composition);
the dispersant butyl glycol (5% w/w of total composition);
the antioxidant TBHQ (0.7% w/w of total composition); and
water (41.8% w/w of total composition).

In another embodiment, the invention relates to the use of the composition as defined anywhere above for nematode control, wherein the nematode is of the Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
a mixture of lycopene (0.75% w/w of total composition) and lutein (0.75% w/w of total composition) dispersed in sunflower oil (6% w/w of total composition);
three tensioactives being polysorbate E20 (15% w/w of total composition), polysorbate E80 (15% w/w of total composition) and polysorbate E85 (15% w/w of total composition);
the dispersant butyl glycol (5% w/w of total composition);
the antioxidant TBHQ (0.7% w/w of total composition); and
water (41.8% w/w of total composition).

In another embodiment, the invention relates to the use of the composition as defined anywhere above for nematode control, wherein the nematode is of the Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat, preferably wherein the nematode is of the genus Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp, more preferably wherein the nematode is of the genus Meloidogyne or Tylenchulus, and even more preferably wherein the nematode is of the genus Meloidogyne spp. or Tylenchulus semipenetrans, and wherein the composition comprises:
a mixture of lutein (1.40% w/w of total composition) and zeaxanthin (0.10% w/w of total composition) dispersed in sunflower oil (6% w/w of total composition);
three tensioactives being polysorbate E20 (15% w/w of total composition), polysorbate E80 (15% w/w of total composition) and polysorbate E85 (15% w/w of total composition);
the dispersant butyl glycol (5% w/w of total composition);
the antioxidant TBHQ (0.7% w/w of total composition); and
water (41.8% w/w of total composition).

Further to the use of the composition, the composition may include water and/or oil.

Further to the use of the composition, the composition may further include nutrients and/or fertilizing compounds and/or biostimulating compounds.

Further to the use of the composition, the composition may further include one or more plant protection products.

A second aspect of the present invention relates to a composition which comprises one or more carotenoids. Typically, said composition may be for use in nematode control. The composition may be a nematicidal composition. The composition may be a nematode control composition.

Any carotenoids as defined herein may be selected. Typically, the carotenoids may be selected from, but not limited to, the following group comprising: lutein, beta-carotene, astaxanthin, lycopene, zeaxanthin and apocarotenal.

The composition may further comprise a dispersant. The dispersant may be selected from, but not limited to, the following group comprising: (C₂-C₁₂) alcohols, ethanol, isopropanol, n-octanol, 2 ethyl-hexanol, glycerin, glycerol, (C₂-C₃₀) alkene glycol, dipropylene glycol, polypropylene glycol, butyl glycol or alkyl ethers thereof, sorbitol, mannitol, dulcitol, ethyl lactate, butyl lactate, 2-ethylhexyl lactate, and/or combinations or derivatives thereof. Preferably the dispersant may include butyl glycol.

The composition may further include a carrier, wherein the carotenoids may be dispersed in said carrier. Preferably the carrier may be a vegetable oil, more preferably the vegetable oil may be selected from, but not limited to, the following group comprising: sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils. Even more preferably the vegetable oil may be selected from, but not limited to, the following group comprising: sunflower oil, corn oil, safflower oil, sunflower oil, soybean oil, avocado oil, jojoba oil, pumpkin oil, grapeseed oil, sesame oil, hazelnut oil, tall oil fatty acid, and glycerol oil. Still more preferably the vegetable oil may be sunflower oil.

The composition may further comprise one or more tensioactives. Said tensioactives may be nonionic and anionic tensioactives. Nonionic tensioactive may include alkoxylated sorbitan fatty esters, ethoxylated sorbitan fatty esters, ethoxylated sorbitol fatty esters, polysorbate E20, polysorbate E80, polysorbate E85, ethoxylated fatty acids, ethoxylated fatty alcohols, ethoxylated and propoxylated fatty acids, ethoxylated and propoxylated fatty alcohols, lecithin, graft acrylic copolymers, alkyl polyglucosides, and/or combinations thereof. Anionic tensioactives may include alkyl benzene sulfonic acid salts, alkyl ether sulfates, alkyl ethoxylated ether sulfates, alkyl polyglycol ether phosphates, alkyl phosphate esters, lignosulfonates, naphthalene sulfonates, ethoxylated tristyrylphenol phosphates, random acrylic copolymers, and/or combinations thereof. Preferably the tensioactives comprise three tensioactives, polysorbate E20, polysorbate E80 and polysorbate E85.

The composition may further comprise an additive selected from, but not limited to, the group comprising: preservatives, humectant, wetting agents, spreaders, compatibilizers, binders, fillers, adhesives, protective colloids, thickeners, thixotropic agents, penetrants, retention promoters, sequestrants, clarifiers, anti-freezing agents, anti-caking agents, hydrotropes, stabilizers, antioxidants, UV/light protectors, acidifiers, alkaline agents, chelates, complexing agents, dyes, rheology modifiers, antifoams, anti-drift agents, and combinations thereof.

Preferably the composition comprises at least an antioxidant or an UV-light protector, such as butyl hydroxyanisole (BHA), butyl hydroxytoluene (BHT), terc-butyl hydroquinone (TBHQ), tocopherols, medium or long chain carboxylic acids, medium or long chain carboxylic salts, propyl galate, nicotinamide, ascorbil palmitate, lignosulfonates, calcium or magnesium carbonate, titanium dioxide, zinc or copper oxide, and combinations thereof.

The composition may further include water, wherein water may be a diluent. The composition may be a water-based composition wherein a major portion (more than 50%) of the composition is water. The composition may further include oils, wherein oil may be a diluent or a carrier. The composition may be an oil-based composition wherein a major portion (more than 50%) of the composition is oil.

The composition may further include nutrients and/or fertilizing compounds and/or biostimulating compounds.

The composition may further include one or more plant protection products.

In an embodiment of the invention the composition comprises:
one or more carotenoids selected from, but not limited to, the group comprising: lutein, beta-carotene, astaxanthin, lycopene, zeaxanthin and apocarotenal;
a carrier being a vegetable oil, more preferably wherein the vegetable oil is selected from sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils, even more preferably wherein the vegetable oil is selected from sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils, and still more preferably wherein the vegetable oil is sunflower oil;
one or more tensioactives, preferably three tensioactives being polysorbate E20, polysorbate E80 and polysorbate E85; and
a dispersant, preferably wherein the dispersant selected from ethanol, isopropanol, glycerol, propylene glycol, butyl glycol, dipropylene glycol and sorbitol, and more preferably wherein the dispersant is butyl glycol.

The composition may further include an antioxidant or an UV-light protector, preferably wherein the antioxidant or UV-light protector is selected from butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and/or combinations thereof, further preferably wherein the antioxidant is terc-butyl hydroquinone (TBHQ) and/or tocopherol and/or propyl galate.

In another embodiment of the composition,
the carotenoid selected from lutein, beta-carotene, astaxanthin, lycopene, zeaxanthin and apocarotenal;
the carrier is a vegetable oil, more preferably wherein the vegetable oil is selected from sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils, even more preferably wherein the vegetable oil is selected from sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils, and still more preferably wherein the vegetable oil is sunflower oil;
one or more tensioactives are three tensioactives polysorbate E20, polysorbate E80 and polysorbate E85;
the dispersant selected from ethanol, isopropanol; glycerol, propylene glycol, butyl glycol, dipropylene glycol and sorbitol; and
an antioxidant or an UV-light protector selected from butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and/or combinations thereof, wherein the antioxidant is terc-butyl hydroquinone (TBHQ) and/or tocopherol and/or propyl galate.

In another embodiment of the composition,
the carotenoid selected from beta-carotene dispersed in sunflower oil, astaxanthin dispersed in sunflower oil, lutein dispersed in sunflower oil, lycopene dispersed in sunflower oil, zeaxanthin dispersed in sunflower oil, and/or apocarotenal dispersed in sunflower oil;
the three tensioactives are polysorbate E20, polysorbate E80 and polysorbate E85;
the dispersant butyl glycol; and
an antioxidant or an UV-light protector being terc-butyl hydroquinone (TBHQ) and/or tocopherol and/or propyl galate.

In another embodiment of the composition,
the carotenoid selected from beta-carotene dispersed in sunflower oil, astaxantin dispersed in sunflower oil, lutein dispersed in sunflower oil, lycopene dispersed in sunflower oil, zeaxanthin dispersed in sunflower oil, and/or apocarotenal dispersed in sunflower oil;
the three tensioactives are polysorbate E20, polysorbate E80 and polysorbate E85;
the dispersant butyl glycol;
the antioxidant or UV-light protector terc-butyl hydroquinone (TBHQ) and/or tocopherol and/or propyl galate; and
   wherein:
the sunflower oil is from 2% to 10% (w/w of total composition);
the carotenoid is from 0.1% to 15% (w/w of total composition);
the tensioactives are from 20% to 50% (w/w of total composition);
the dispersant is from 2% to 10% (w/w of total composition); and
the antioxidant is from 0.05% to 5% (w/w of total composition).

The composition as defined anywhere above, wherein the composition may additionally include water from is from 0.1% to 60% (w/w of total composition).

In another embodiment of the composition,
the carotenoid is beta-carotene (1.5% w/w of total composition) dispersed in sunflower oil (6% w/w of total composition);
the tensioactives are polysorbate E20 (15% w/w of total composition), polysorbate E80 (15% w/w of total composition) and polysorbate E85 (15% w/w of total composition);
the dispersant is butyl glycol (5% w/w of total composition);
the antioxidant or UV-light protector is terc-butyl hydroquinone (TBHQ) and/or tocopherol and/or propyl galate (0.7% w/w of total composition); and
water (41.8% w/w of total composition).

In another embodiment of the composition,
the carotenoid is astaxanthin (1.5% w/w of total composition) dispersed in sunflower oil (6% w/w of total composition);
the tensioactives are polysorbate E20 (15% w/w of total composition), polysorbate E80 (15% w/w of total composition) and polysorbate E85 (15% w/w of total composition);
the dispersant is butyl glycol (5% w/w of total composition);
the antioxidant or UV-light protector is terc-butyl hydroquinone (TBHQ) and/or tocopherol and/or propyl galate (0.7% w/w of total composition); and
water (41.8% w/w of total composition).

In another embodiment of the composition,
the carotenoid is lutein (1.5% w/w of total composition) dispersed in sunflower oil (6% w/w of total composition);
the tensioactives are polysorbate E20 (15% w/w of total composition), polysorbate E80 (15% w/w of total composition) and polysorbate E85 (15% w/w of total composition);
the dispersant is butyl glycol (5% w/w of total composition);
the antioxidant or UV-light protector is terc-butyl hydroquinone (TBHQ) and/or tocopherol and/or propyl galate (0.7% w/w of total composition); and
water (41.8% w/w of total composition).

In another embodiment of the composition,
the carotenoid is lycopene (1.5% w/w of total composition) dispersed in sunflower oil (6% w/w of total composition);
the tensioactives are polysorbate E20 (15% w/w of total composition), polysorbate E80 (15% w/w of total composition) and polysorbate E85 (15% w/w of total composition);
the dispersant is butyl glycol (5% w/w of total composition);
the antioxidant or UV-light protector is terc-butyl hydroquinone (TBHQ) and/or tocopherol and/or propyl galate (0.7% w/w of total composition); and
water (41.8% w/w of total composition).

In another embodiment of the composition,
the carotenoid is a mixture of lycopene (0.75% w/w of total composition) and lutein (0.75% w/w of total composition) dispersed in sunflower oil (6% w/w of total composition);
the tensioactives are polysorbate E20 (15% w/w of total composition), polysorbate E80 (15% w/w of total composition) and polysorbate E85 (15% w/w of total composition);
the dispersant is butyl glycol (5% w/w of total composition);
the antioxidant or UV-light protector is terc-butyl hydroquinone (TBHQ) and/or tocopherol and/or propyl galate (0.7% w/w of total composition); and
water (41.8% w/w of total composition).

In another embodiment of the composition,
the carotenoid is a mixture of lutein (1.40% w/w of total composition) and zeaxanthin (0.10% w/w of total composition) dispersed in sunflower oil (6% w/w of total composition);
the tensioactives are polysorbate E20 (15% w/w of total composition), polysorbate E80 (15% w/w of total composition) and polysorbate E85 (15% w/w of total composition);
the dispersant is butyl glycol (5% w/w of total composition);
the antioxidant or UV-light protector is terc-butyl hydroquinone (TBHQ) and/or tocopherol and/or propyl galate (0.7% w/w of total composition); and
water (41.8% w/w of total composition).

When in use, the composition according to any embodiments of the second aspect may be for nematode control, wherein the nematode may be at least one, but not limited to, the following group of genus comprising: Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina. Preferably, when in use, the composition may be for nematode control, wherein the nematode may be at least one, but not limited to, the following group: Xiphinema spp., Tylenchulus semipenetrans, Pratylenchus spp., Rotylenchus sp., Tylenchorhynchus spp., Helicotylenchus spp., Meloidogyne spp., Tylenchus spp. or Rhabditis spp. More preferably when in use, the composition may be for nematode control, wherein the nematode may be at least one, but not limited to, the following group: Meloidogyne or Tylenchulus, and even more preferably wherein the nematode is of the genus Meloidogyne spp. or Tylenchulus semipenetrans.

There is further provided for the use according to the first aspect and/or the composition according to the second aspect, substantially as described herein with reference to any of the accompanying figures and/or examples.

### BRIEF DESCRIPTION OF THE DRAWINGS

Embodiments of the disclosure will be described below by way of example only and with reference to the accompanying drawings in which:

FIG. 1 shows the J2 nematode population (number of J2/150 cm³ of soil) counted in the soil samples collected 21 days after application G (21 DAG) and at harvest (36 days after application H (36 DAH));

FIG. 2 presents the number eggs+J2 (number of eggs+J2/g of tuber peel) counted in the tuber samples collected at harvest (110 after planting—36 days after application H (36 DAH));

FIG. 3 presents the total tuber yield in the different treatments (expressed in Ton/ha);

FIG. 4 presents the number of tubers/size index harvested in the different treatments;

FIG. 5 shows the bar plot showing the crop vigor in the different treatments,

FIG. 6 presents the crop height data recorded 16 days after application 1 (16 DAI);

FIG. 7 presents the aerial part fresh weight data recorded 16 days after application I (16 DAI);

FIG. 8 presents the fresh root weight data recorded 16 days after application I (16 DAI).

FIG. 9 shows the J2 nematode population (number of J2/200 cm³ of soil) counted in the soil samples collected before the start of the trial and 16 days after application I (16 DAI);

FIG. 10 shows the eggs population (number of eggs/200 cm³ of soil) counted in the soil samples collected 16 days after application I (16 DAI);

FIG. 11 shows the J2 nematode population (number of J2/g of roots) counted in the root samples collected 16 days after application I (16 DAI);

FIG. 12 shows the eggs population (number of eggs/g of roots) counted in the root samples collected 16 days after application I (16 DAI);

FIG. 13 presents the total number of fruits harvested in the different treatments (expressed in Number of fruits/plot);

FIG. 14 presents the total production (Yield) of the different treatments in kg/ha; and

FIG. 15 presents the sugar content (in ° Brix) of the fruits harvested in the different treatments.

As used throughout this specification herein above and/or below, the term “nematode control” also refers to “nematicide” or “control of nematodes” and includes both nematode killing and repellency effects and includes effects on nematode growth, lifecycle, mobility, feeding capacity, metabolic function, reproductive capacity, egg laying ability, egg laying frequency and numbers of eggs laid. As used herein, the term nematistatic refers to rendering nematodes immobile, and includes permanent and/or temporary immobility.

The term “carotenoid” or “carotenoids” used throughout this specification herein above and/or below refers to compounds that are members of the structurally diverse class of naturally occurring or synthetic carotenoid pigments, and structural analogues thereof. Carotenoid compounds are typically obtained from isoprenoid pathway intermediates. Carotenoids can be acyclic or cyclic, and may or may not contain oxygen, so that the term “carotenoids”, in some embodiments, can include both carotenes and xanthophylls. Many carotenoids have strong light absorbing properties. In general, carotenoids are hydrocarbon compounds having a conjugated polyene carbon skeleton formally derived from the five-carbon compound isopentenyl pyrophosphate. In some embodiments, carotenoid compounds may be triterpenes (C30 diapocarotenoids), tetraterpenes (C40 carotenoids), or other compounds that are, for example, C35, C50, C60, C70, C80 in length or other lengths (wherein the number after the letter C denotes the length of a carbon chain). In some embodiments, a carotenoid may have a length more than C200. More than 1000 different carotenoids have been identified in nature. Carotenoids include but are not limited to: apocarotenal, retinol, retinal, antheraxanthin, adonirubin, adonixanthin, astaxanthin, canthaxanthin, capsorubrin, beta-cryptoxanthin, alfa-carotene, beta-carotene, β,ψ-carotene, delta-carotene, ε-carotene, echinenone, 3-hydroxyechinenone, 3′-hydroxyechinenone, γ-carotene, γ-carotene, 4-keto-γ-carotene, ζ-carotene, α-cryptoxanthin, deoxyflexixanthin, diatoxanthin, 7,8-didehydroastaxanthin, didehydrolycopene, fucoxanthin, fucoxanthinol, isorenieratene, β-isorenieratene, lactucaxanthin, lutein, lycopene, neurosporaxanthin, myxobactone, neoxanthin, neurosporene, hydroxyneurosporene, peridinin, phytoene, rhodopin, rhodopin glucoside, 4-keto-rubixanthin, siphonaxanthin, spheroidene, spheroidenone, spirilloxanthin, torulene, 4-keto-torulene, 3-hydroxy-4-keto-torulene, uriolide, uriolide acetate, violaxanthin, zeaxanthin-beta-diglucoside, zeaxanthin, and C30 carotenoids. Additionally, carotenoid compounds include derivatives of these molecules, which may include hydroxy-, methoxy-, oxo-, epoxy-, carboxy-, or aldehydic functional groups. For example, carotenoids include oxygenated derivatives. Further, included carotenoid compounds include ester (e.g., glycoside ester, fatty acid ester) and sulfate derivatives (e.g., esterified xanthophylls).

Unless otherwise defined, all technical and scientific terms used herein have the same meaning as commonly understood by one of ordinary skilled in the art to which this invention belongs. Methods and materials similar or equivalent to those described herein can be used in the practice of the present invention. Throughout the description and claims the word “comprise” and its variations are not intended to exclude other technical features, additives, components, or steps. Additional objects, advantages and features of the invention will become apparent to those skilled in the art upon examination of the description or may be learned by practice of the invention. The following examples are provided by way of illustration and are not intended to be limiting of the present invention.

### Non-Limiting Examples

The examples of the disclosure should not be interpreted as non-limiting.

A number of compositions as described above, particularly preferred embodiments of the invention, were tested as nematode control compositions.

Table 1—shows an example embodiment of the composition according to the invention and possible components able to produce the invention.

| Item | Description | Compound | Weight of Total (%) |
|---|---|---|---|
| 1. | Active | Carotenoids including lutein, beta-carotene, | between about 0.1 w/w % |
| | ingredients | astaxanthin, lycopene, zeaxanthin, | to about 15 w/w % (preferred |
| | | apocarotenal and/or mixtures thereof. | between about 0.2 w/w % to |
| | | | about 7.5 w/w %) |
| 2. | Solvent/ | Vegetable oils, sunflower oil, corn oil, | between about 2.0 w/w % |
| | carriers | safflower oil, sunflower oil, soybean oil, | to about 10 w/w % |
| | | avocado oil, jojoba oil, pumpkin oil, | (preferred between about |
| | | grapeseed oil, sesame oil, hazelnut oil, | 4.0 w/w % to about 8.0 |
| | | alkylated seed oil, tall oil fatty acid, | w/w %) |
| | | glycerol oil and glycerine vegetable ester | |
| | | oils and/or derivatives thereof. | |
| 3. | Dispersants | (C₂—C₁₂) alcohols, ethanol, isopropanol, | between about 2 w/w % to |
| | | n-octanol, 2 ethyl-hexanol, glycerin, glycerol, | about 10 w/w % (between |
| | | (C₂—C₃₀) alkene glycol, dipropylene glycol, | about 3 w/w % to about 8 |
| | | polypropylene glycol, butyl glycol or alkyl | w/w %) |
| | | ethers thereof, sorbitol, mannitol, dulcitol, | |
| | | ethyl lactate, butyl lactate, 2-ethylhexyl | |
| | | lactate, and/or combinations or derivatives | |
| | | thereof. | |
| 4. | Tensioactives/ | Nonionic tensioactives including | between about 20 w/w % to |
| | surfactants | alkoxylated sorbitan fatty esters, | about 50 w/w % (preferably |
| | | alkoxylated sorbitol fatty esters, ethoxylated | between about 30 w/w % to |
| | | sorbitan fatty esters, ethoxylated sorbitol | about 45 w/w %) |
| | | fatty esters, polysorbate E20, polysorbate | |
| | | E80, polysorbate E85, ethoxylated fatty | |
| | | acids, ethoxylated fatty alcohols, | |
| | | ethoxylated and propoxylated fatty acids, | |
| | | ethoxylated and propoxylated fatty alcohols, | |
| | | lecithin, graft acrylic copolymers, alkyl | |
| | | polyglucoside, and/ or combinations thereof; | |
| | | Anionic tensioactives including alkyl | |
| | | benzene sulfonic acid salts, alkyl ether | |
| | | sulfates, alkyl ethoxylated ether sulfates, | |
| | | alkyl polyglycol ether phosphates, alkyl | |
| | | phosphate esters, lignosulfonates, | |
| | | naphthalene sulfonates, ethoxylated | |
| | | tristyrylphenol phosphates, random acrylic | |
| | | copolymers, and/or combinations thereof. | |
| 5. | Stabilizers/ | butyl hydroxyanisole (BHA), butyl | between about 0.05 w/w % |
| | antioxidant/ | hydroxytoluene (BHT), terc-butyl | to about 5 w/w % |
| | UV light | hydroquinone (TBHQ), tocopherols, | (preferred between about |
| | protector | medium or long chain carboxylic acids, | 0.1 w/w % to about 2.0 |
| | | medium or long chain carboxylic salts, | w/w %) |
| | | propyl galate, nicotinamide, ascorbil | |
| | | palmitate, lignosulfonates, calcium or | |
| | | magnesium carbonate, titanium dioxide, | |
| | | zinc or copper oxide, and combinations | |
| | | thereof | |
| 6. | Diluent/filler | Water | between about 0.1 w/w % |
| | | | to about 60 w/w % |
| | | | (preferably between about |
| | | | 1 w/w % to about 45 |
| | | | w/w %) |
| Total: | | | 100 |

### Example 1: Process for Preparing 100 g of Composition of Reference N-09-02

N-09-02: Composition that contains beta-carotene (1.5% w/w of total composition) dispersed in sunflower oil (6% w/w), and mixed with:
three tensioactives: polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition).

To 1.50 g of pure beta-carotene in a 250 mL beaker were added 6.0 g of sunflower oil at room temperature. The mixture was gently stirred using a glass rod until a homogeneous dispersion was obtained. Then a magnetic stirring bar was added and 15.0 g of polysorbate E20, 15.0 g of polysorbate E80 and 15.0 g of polysorbate E85 were sequentially poured into the mixture with continuous stirring. At this point, 5.0 g of butyl glycol and 0.7 g of TBHQ were added and the stirring continued until complete homogenization. Finally, the mixture was made up to 100.0 g by adding 41.8 g of distilled water and further stirring for 60 minutes. The final product was then transferred to a 250 mL amber-glass bottle and stored at room temperature for later use in bioactivity trials.

| | % w/w of total |
|---|---|
| Pre-mix | composition |
| SUNFLOWER OIL | 6.0 |
| B-CAROTENE | 1.5 |

| | % w/w of total |
|---|---|
| Add the Pre-mix to: | composition |
| POLYSORBATE 20 | 15.0 |
| POLYSORBATE 80 | 15.0 |
| POLYSORBATE 85 | 15.0 |
| BUTYL GLYCOL | 5.0 |
| TBHQ | 0.7 |
| WATER | 41.8 |
| TOTAL | 100.00 |

### Example 2: Process for Preparing 100 g of Composition of Reference N-09-03

N-09-03: Composition that contains astaxanthin (1.5% w/w of total composition) dispersed in sunflower oil (6% w/w of total composition), and mixed with:
three tensioactives: polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

To 1.50 g of pure astaxanthin in a 250 mL beaker were added 6.0 g of sunflower oil at room temperature. The mixture was gently stirred using a glass rod until a homogeneous dispersion was obtained. Then a magnetic stirring bar was added and 15.0 g of polysorbate E20, 15.0 g of polysorbate E80 and 15.0 g of polysorbate E85 were sequentially poured into the mixture with continuous stirring. At this point, 5.0 g of butyl glycol and 0.7 g of TBHQ were added and the stirring continued until complete homogenization. Finally, the mixture was made up to 100.0 g by adding 41.8 g of distilled water and further stirring for 60 minutes. The final product was then transferred to a 250 mL amber-glass bottle and stored at room temperature for later use in bioactivity trials.

| | % w/w of total |
|---|---|
| Pre-mix | composition |
| SUNFLOWER OIL | 6.0 |
| ASTAXANTHIN | 1.5 |

| | % w/w of total |
|---|---|
| Add the Pre-mix to: | composition |
| POLYSORBATE 20 | 15.0 |
| POLYSORBATE 80 | 15.0 |
| POLYSORBATE 85 | 15.0 |
| BUTYL GLYCOL | 5.0 |
| TBHQ | 0.7 |
| WATER | 41.8 |
| TOTAL | 100.00 |

### Example 3: Process for Preparing 100 g of Composition of Reference N-09-04

N-09-04: Composition that contains lutein (1.5% w/w of total composition) dispersed in sunflower oil (6% w/w of total composition), and mixed with:
three tensioactives: polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

To 1.50 g of pure lutein in a 250 mL beaker were added 6.0 g of sunflower oil at room temperature. The mixture was gently stirred using a glass rod until a homogeneous dispersion was obtained. Then a magnetic stirring bar was added and 15.0 g of polysorbate E20, 15.0 g of polysorbate E80 and 15.0 g of polysorbate E85 were sequentially poured into the mixture with continuous stirring. At this point, 5.0 g of butyl glycol and 0.7 g of TBHQ were added and the stirring continued until complete homogenization. Finally, the mixture was made up to 100.0 g by adding 41.8 g of distilled water and further stirring for 60 minutes. The final product was then transferred to a 250 mL amber-glass bottle and stored at room temperature for later use in bioactivity trials.

| | % w/w of total |
|---|---|
| Pre-mix | composition |
| SUNFLOWER OIL | 6.0 |
| LUTEIN | 1.5 |

| | % w/w of total |
|---|---|
| Add the Pre-mix to: | composition |
| POLYSORBATE 20 | 15.0 |
| POLYSORBATE 80 | 15.0 |
| POLYSORBATE 85 | 15.0 |
| BUTYL GLYCOL | 5.0 |
| TBHQ | 0.7 |
| WATER | 41.8 |
| TOTAL | 100.00 |

### Example 4: Process for Preparing 100 g of Composition of Reference N-09-06

N-09-06: Composition that contains lycopene (1.5% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of the total composition) acting as an UV light protector, and
water (41.8% w/w of total composition)

To 1.50 g of pure lycopene in a 250 mL beaker were added 6.0 g of sunflower oil at room temperature. The mixture was gently stirred using a glass rod until a homogeneous dispersion was obtained. Then a magnetic stirring bar was added and 15.0 g of polysorbate E20, 15.0 g of polysorbate E80 and 15.0 g of polysorbate E85 were sequentially poured into the mixture with continuous stirring. At this point, 5.0 g of butyl glycol and 0.7 g of TBHQ were added and the stirring continued until complete homogenization. Finally, the mixture was made up to 100.0 g by adding 41.8 g of distilled water and further stirring for 60 minutes. The final product was then transferred to a 250 mL amber-glass bottle and stored at room temperature for later use in bioactivity trials.

| | % w/w of total |
|---|---|
| Pre-mix | composition |
| SUNFLOWER OIL | 6.0 |
| LYCOPENE | 1.5 |

| | % w/w of total |
|---|---|
| Add the Pre-mix to: | composition |
| POLYSORBATE 20 | 15.0 |
| POLYSORBATE 80 | 15.0 |
| POLYSORBATE 85 | 15.0 |
| BUTYLGLYCOL | 5.0 |
| TBHQ | 0.7 |
| WATER | 41.8 |
| TOTAL | 100.00 |

### Example 5: Process for Preparing 100 g of Composition of Reference C-10-29

C-10-29: Composition that contains the mixture of lycopene (0.75% w/w of total composition) and lutein (0.75% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

To 0.75 g of pure lycopene and 0.75 g of pure lutein in a 250 mL beaker were added 6.0 g of sunflower oil at room temperature. The mixture was gently stirred using a glass rod until a homogeneous dispersion was obtained. Then a magnetic stirring bar was added and 15.0 g of polysorbate E20, 15.0 g of polysorbate E80 and 15.0 g of polysorbate E85 were sequentially poured into the mixture with continuous stirring. At this point, 5.0 g of butyl glycol and 0.7 g of TBHQ were added and the stirring continued until complete homogenization. Finally, the mixture was made up to 100.0 g by adding 41.8 g of distilled water and further stirring for 60 minutes. The final product was then transferred to a 250 mL amber-glass bottle and stored at room temperature for later use in bioactivity trials.

| | % w/w of total |
|---|---|
| Pre-mix | composition |
| SUNFLOWER OIL | 6.0 |
| LYCOPENE | 0.75 |
| LUTEIN | 0.75 |

| | % w/w of total |
|---|---|
| Add the Pre-mix to: | composition |
| POLYSORBATE 20 | 15.0 |
| POLYSORBATE 80 | 15.0 |
| POLYSORBATE 85 | 15.0 |
| BUTYLGLYCOL | 5.0 |
| TBHQ | 0.7 |
| WATER | 41.8 |
| TOTAL | 100.00 |

### Example 6: Process for Preparing 100 g of Composition of Reference C-10-30

C-10-30: Composition that contains the mixture of lycopene (1.00% w/w of total composition) and apocarotenal (0.50% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

To 1.00 g of pure lycopene and 0.50 g of pure apocarotenal in a 250 mL beaker were added 6.0 g of sunflower oil at room temperature. The mixture was gently stirred using a glass rod until a homogeneous dispersion was obtained. Then a magnetic stirring bar was added and 15.0 g of polysorbate E20, 15.0 g of polysorbate E80 and 15.0 g of polysorbate E85 were sequentially poured into the mixture with continuous stirring. At this point, 5.0 g of butyl glycol and 0.7 g of TBHQ were added and the stirring continued until complete homogenization. Finally, the mixture was made up to 100.0 g by adding 41.8 g of distilled water and further stirring for 60 minutes. The final product was then transferred to a 250 mL amber-glass bottle and stored at room temperature for later use in bioactivity trials.

| | % w/w of total |
|---|---|
| Pre-mix | composition |
| SUNFLOWER OIL | 6.0 |
| LYCOPENE | 1.00 |
| APOCAROTENAL | 0.50 |

| | % w/w of total |
|---|---|
| Add the Pre-mix to: | composition |
| POLYSORBATE 20 | 15.0 |
| POLYSORBATE 80 | 15.0 |
| POLYSORBATE 85 | 15.0 |
| BUTYLGLYCOL | 5.0 |
| TBHQ | 0.7 |
| WATER | 41.8 |
| TOTAL | 100.00 |

Other mixtures of carotenoids were prepared according to the invention for tests and trials:

C-10-31: Composition that contains the mixture of lycopene (0.75% w/w of total composition) and beta-carotene (0.75% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

C-10-32: Composition that contains the mixture of lutein (1.00% w/w of total composition) and apocarotenal (0.50% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

C-10-33: Composition that contains the mixture of beta-carotene (0.75% w/w of total composition) and apocarotenal (0.75% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

C-10-34: Composition that contains the mixture of lycopene (0.75% w/w of total composition) and astaxanthin (0.75% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition)

The applicant describes below, without any limitations of the invention, some combinations of carotenes, carriers, tensioactives, dispersants, antioxidants and/or additives that can be produced according to the invention:

C-11-35 Composition that contains carotenoids in an oil-based EC or OD composition.
two tensioactives ethoxylated fatty acids and polysorbate E85;
the solvent soybean oil methyl ester;
the dispersant is a polymer; and
the antioxidant TBHQ.
wherein:
the soybean oil is from 50% to 70% (w/w of total composition);
the carotenoid is from 0.1% to 15% (w/w of total composition);
the tensioactives are from 20% to 40% (w/w of total composition);
the dispersant is from 2% to 5% (w/w of total composition); and
the antioxidant is from 0.05% to 5% (w/w of total composition).

C-11-36 Composition that contains carotenoids in an oil-based EC or OD composition.
two tensioactives ethoxylated fatty acids and ethoxylated fatty alcohol;
the solvent sunflower oil;
the dispersant is benzene sulfonate calcium salt; and
the antioxidant BHT.
wherein:
the sunflower oil is from 50% to 70% (w/w of total composition);
the carotenoid is from 0.1% to 15% (w/w of total composition);
the tensioactives are from 20% to 40% (w/w of total composition);
the dispersant is from 2% to 5% (w/w of total composition); and
the antioxidant is from 0.05% to 5% (w/w of total composition).

C-11-37 Composition that contains carotenoids in an oil-based EC or OD composition.
three tensioactives polysorbate E85, polysorbate E20 and ethoxylated fatty alcohol;
the solvent rapeseed oil methyl ester;
the dispersant is a polymer;
the rheological modifier is a modified silica; and
the antioxidant tocoferol and propylgalate.
wherein:
the rapeseed oil methyl ester is from 50% to 70% (w/w of total composition);
the carotenoid is from 0.1% to 15% (w/w of total composition);
the tensioactives are from 20% to 40% (w/w of total composition);
the dispersant is from 2% to 5% (w/w of total composition);
the rheological modifier is from 2% to 5% (w/w of total composition); and
the antioxidant is from 0.05% to 5% (w/w of total composition).

C-11-38 Composition that contains mixture of carotenoids in an oil-based EC or OD composition.
three tensioactives polysorbate E20, polysorbate E80, polysorbate E85;
the solvent water and sunflower oil;
the dispersant propylglycol; and
the antioxidant TBHQ.
wherein:
the sunflower oil and water are from 40% to 60% (w/w of total composition);
the carotenoid 1 is from 0.1% to 10% (w/w of total composition);
the carotenoid 2 is from 0.1% to 10% (w/w of total composition);
the tensioactives are from 20% to 50% (w/w of total composition);
the dispersant is from 2% to 5% (w/w of total composition); and
the antioxidant is from 0.05% to 5% (w/w of total composition).

C-11-39 Composition that contains mixture of carotenoids in an oil-based EC or OD composition.
three tensioactives polysorbate E20, polysorbate E80, polysorbate E85;
the solvent water and sunflower oil;
the dispersant butylglycol and polymeric compounds; and
the antioxidant TBHQ.
wherein:
the sunflower oil is from 40% to 60% (w/w of total composition);
the carotenoid 1 is from 0.1% to 10% (w/w of total composition);
the carotenoid 2 is from 0.1% to 10% (w/w of total composition);
the tensioactives are from 20% to 40% (w/w of total composition);
the dispersant is from 2% to 5% (w/w of total composition); and
the antioxidant is from 0.05% to 5% (w/w of total composition).

C-11-40 Composition that contains mixture of carotenoids in an oil-based EC or OD composition.
three tensioactives polysorbate E20, polysorbate E85, ethoxylated fatty acid;
the solvent soybean oil;
the dispersant propylglycol and polymeric compounds; and
the antioxidant TBHQ.
wherein:
the soybean oil is from 40% to 60% (w/w of total composition);
the carotenoid 1 is from 0.1% to 10% (w/w of total composition);
the carotenoid 2 is from 0.1% to 10% (w/w of total composition);
the tensioactives are from 20% to 40% (w/w of total composition);
the dispersant is from 2% to 5% (w/w of total composition); and
the antioxidant is from 0.05% to 5% (w/w of total composition).

### Example 7: Effect of Different Carotenoids on Nematode Motility

The aim of this trial was to determine the contact effect of N-09-02, N-09-03, N-09-04, N-09-06 applied in aqueous dissolution on J2 of Meloidogyne incognita in Petri dishes.

Root-knot nematodes were collected in commercial fields with known problems of this pest in Torre Pacheco (Campo de Cartagena, Murcia). For trial extraction of nematodes, several egg masses were isolated and were placed in a Baermann tray, where Meloidogyne incognita eggs hatched. Individuals used were less than 24 hours-old after hatching to ensure that they were second-stage juveniles (J2).

The elemental plots consisted of one Petri dish filled with aqueous solution of the products (3 mL/L) with distilled water (2.0 mL/Petri dish). 200 individuals were introduced in each Petri dish. For each treatment 4 replications were run.

Assessments were carried out at 0, 24, 48, 72, 120 and 144 hours after test start. Nematode health and movement were assessed, using the observer criteria: nematodes with normal move were designated as “motion” (meaning motile individuals with infective capabilities), and nematodes without move were designated as “motionless”. Table 2 details the evolution of the percentage of motile J2 Meloidogyne incognita upon exposure to the different carotenoids with time. Means followed by the same letter do not significantly differ (P=0.05, Student-Newman-Keuls).

For each assessment, J2 were observed under stereoscopic microscope, when assignation was not evident, nematodes were touched carefully with the entomologic needle to verify the motility. In all cases death nematodes were maintained in the Petri dishes and observed in each assessment to verify the recovery of motility during the time. In this way it was confirmed that nematodes recovered their motion. This effect is used to confirm that the products have a clear nematostatic effect.

TABLE 2

| Treatment | Carotenoid | 0 h | 24 h | 48 h | 72 h | 96 h | 120 h | 144 h |
|---|---|---|---|---|---|---|---|---|
| Untreated | None | 100.00a | 100.00a | 100.00a | 100.00a | 98.75a | 98.20a | 97.50a |
| N-09-02 | β-Carotene | 100.00a | 100.00a | 100.00a | 96.50b | 91.50b | 31.75b | 21.25b |
| N-09-03 | Astaxanthin | 100.00a | 100.00a | 82.75c | 68.25e | 47.00c | 26.50c | 19.75b |
| N-09-04 | Lutein | 100.00a | 100.00a | 91.25b | 85.25d | 38.50d | 32.75b | 11.75c |
| N-09-06 | Lycopene | 100.00a | 100.00a | 92.00b | 92.25c | 47.25c | 13.50d | 2.25d |

All the tested solutions were clearly active when compared to control, affecting the motility of J2 individuals of Meloidogyne incognita in detriment of their root-infecting capabilities. All tested solutions show nematode control.

### Example 8: Nematicidal Activity of N-09-04 and N-09-06 Formulations Against Nematodes in Liquid Medium at Two Different Concentrations

The objective of this study was to test the efficacy of the products N-09-04 and N-09-06 against nematodes at two different doses (5.0 and 7.5 mL/L). The population of nematodes used for the tests was a mix of the following species: Xiphinema spp., Tylenchulus semipenetrans, Pratylenchus spp., Tylenchorhynchus spp., Helicotylenchus spp., Meloidogyne spp., Tylenchus spp., Rhabditis spp., at a similar ratio.

Test unit consisted in a Petri-dish containing 10 mL of the selected solution, to which 50 nematodes per were added. Motion ability was registered at different times, nematodes were considered alive if they spontaneously moved or after being mechanically stimulated with a thin wire. At the end of the study, the nematodes were exposed to a solution of NaOH to confirm the equivalence of immobility to mortality.

Results for number of surviving nematodes are shown in Table 3. Values were obtained from the average of 3 replicates per treatment. Means followed by the same letter do not significantly differ (P=0.05, Student-Newman-Keuls).

TABLE 3

| | Time after treatment | | | | | |
|---|---|---|---|---|---|---|
| | 0 h | 4 h | 24 h | 48 h | 5 days | 7 days |
| CONTROL | 50.0a | 50.0a | 50.0a | 50.0a | 50.0a | 50.0a |
| N-09-04 | 50.0a | 50.0a | 50.0a | 47.0a | 32.0bc | 33.0d |
| 5.0 mL/L | | | | | | |
| N-09-04 | 50.0a | 50.0a | 39.0b | 25.0b | 3.7d | 9.0e |
| 7.5 mL/L | | | | | | |
| N-09-06 | 50.0a | 50.0a | 50.0a | 48.7c | 23.3 | 40.7c |
| 5.0 mL/L | | | | | | |
| N-09-06 | 50.0a | 50.0a | 39.3b | 26.0b | 3.0d | 10.3e |
| 7.5 mL/L | | | | | | |

The result shows that all the compositions have a nematicidal effect comparing with the control. The compositions showed nematode control.

### Example 9: Nematicidal Activity of N-09-04 Against Tylenchulus semipenetrans

The aim of this study was to evaluate the mode of action and the efficacy of product N-09-04 at 2 concentrations (5.0 and 7.0 mL/L) against Tylenchulus semipenetrans compared to an untreated control.

The experimental units were 12 L-capacity pots containing a sandy soil with a high population of the nematodes. The same batch of homogenised soil was used to fill all the units. The pots were irrigated to dripping with the corresponding treatment. After 7 days, the population of alive Tylenchulus semipenetrans was determined by examination of a soil sample under the microscope and expressed as number of individuals per 100 g of soil.

Results for number of surviving nematodes are shown in Table 4. Values were obtained from the average of 3 replicates per treatment. Means followed by the same letter do not significantly differ (P=0.05, Student-Newman-Keuls).

TABLE 4

| | Dose | Number of alive Tylenchulus |
|---|---|---|
| Treatment | (mL/L) | semipenetrants in 100 g of soil |
| CONTROL | — | 2,444.0a |
| N-09-04 | 5.0 | 43.7b |
| N-09-04 | 7.0 | 19.7c |

The result shows that all the compositions have a nematicidal effect comparing with the control.

### Example 10: Comparative Field Trial Using N-09-04 vs. Commercial References Against Tylenchulus semipenetrans

The objective of this trial was to demonstrate the efficacy of the product N-09-04 against Tylenchulus semipenetrans in citrus under real field conditions. The following commercial nematicide products were used as references: Tervigo® (Abamectin, 2%), Velum® Prime (Fluopyram, 40%), BioAct® Prime (Paecilomyces lilacinus Strain 251, 21.6%).

Trial was performed in a Citrus sinensis L. orchard located in La Vall d'Uixò (Castelló, Spain). Random plot design was used for the field trial, with three replicates. The different treatments were applied to the soil using the drip irrigation system. Soil was sampled near the roots and nematodes were isolated using Baermann-funnel method. All the extracted liquid sample was analyzed and alive nematodes were counted. The first assessment was done before starting the trial, to check if the population was established and to know the initial population. After that, two more assessments were carried out at 7 and 24 days after the treatment.

Results for number of surviving nematodes are shown in Table 5. Efficacy values are shown in brackets. Means followed by the same letter do not significantly differ (P=0.05, Student-Newman-Keuls).

TABLE 5

| Time after treatment | 0 days | 7 days | 24 days |
|---|---|---|---|
| CONTROL | 1,796a | 1,945a | 2,283a |
| Untreated | | (0%) | (0%) |
| N-09-04 | 1,522a | 322b | 148b |
| 6.0 L/Ha | | (83.4%) | (93.5%) |
| Tervigo ® | 1,438a | 295b | 239b |
| 2.4 L/Ha | | (84.4%) | (89.5%) |
| Velum ® Prime | 1,662a | 3b | 6b |
| 0.375 L/Ha | | (99.8%) | (99.7%) |
| BioAct ® Prime | 1,701a | 45b | 35b |
| 0.75 L/Ha | | (97.7%) | (98.5%) |

The results shown that product N-09-04 has nematode control efficacy against Tylenchulus semipenetrans in citrus under real field conditions.

### Example 11: Comparative Field Trial Using N-09-04 and N-09-06 vs. Commercial Reference

The aim of this study was to evaluate the efficacy of N-09-04 and N-09-06 for the control of soil pathogenic nematodes in tomato (Solanum lycopersicum) under greenhouse conditions.

The trial was carried out in Valle de Santiago (Guanajuato, Mexico). A commercial organic nematicide was selected as reference (Majesty®, Arvensis). For all the treatments, three applications were made using the drip irrigation system, spaced 10 days apart.

Soil was sampled near the roots and alive nematodes were isolated and counted. Upon microscopic analysis, the nematode populations shown to be a consistent mixture of Rotylenchus sp. and Telotylenchus sp. Three samples per treatment were taken in order to provide representative results. An initial assessment was made just before the first application and a second one 7 days after the third application. Percentage of population growth was calculated from those values in order to compare the nematicide capability of each treatment as shown in Table 6.

TABLE 6

| Treatment | Initial | Final | % Population growth |
|---|---|---|---|
| CONTROL | 13 | 53 | 300% |
| N-09-04 | 13 | 20 | 54% |
| (6 L/ha) | | | |
| N-09-06 | 7 | 0 | −100% |
| (6 L/ha) | | | |
| Majesty ® | 33 | 14 | −57% |
| (6 L/ha) | | | |

All the treatments were found to show effective nematode control by decreasing their populations when compared to an untreated reference.

### Example 12: Comparative Field Trial Using N-09-04 at Different Doses Vs. Commercial References

The aim of this study was to evaluate the efficacy N-09-04 for the control of Meloidogyne sp. in tomato (Solanum lycopersicum) under greenhouse conditions.

The trial was carried out in Xilxes (Castelló, Spain) on potted tomato plant seedling (cv. Optima), just after transplanting. A batch of homogeneized and highly nematode-infested soil was employed for all the pots.

N-09-04 was tested at three concentrations (6.0, 7.5 and 9.0 mL/L). The following commercial nematicide products were used as references: Velum® Prime (Fluopyram, 40%) and BioAct® Prime (Paecilomyces lilacinus Strain 251, 21.6%). For all the treatments, the containers were irrigated to dripping with the corresponding treatment.

All the soil in the pots was sampled at 50 days after application and alive nematodes were isolated and counted. Three replicates per treatment were assessed at every time point. Number of Meloidogyne sp. inside the roots (individual per gram of root) was calculated from nematode counts and root weight in order to compare the nematicide capability of each treatment as shown in Table 7. Means followed by the same letter do not significantly differ (P=0.05, Student-Newman-Keuls).

TABLE 7

| | Dose | Meloidogyne sp. |
|---|---|---|
| Treatment | (mL/L) | (individuals/gram of root) |
| CONTROL | — | 2,056 a |
| N-09-04 | 6.0 | 374 b |
| N-09-04 | 7.5 | 156 b |
| N-09-04 | 9.0 | 170 b |
| Velum ® Prime | 0.375 | 87 b |
| BioAct ® Prime | 1.0 | 661 b |

The results shown that product N-09-04 is efficient for nematode control, particularly the control of Meloidogyne sp. in tomato, under greenhouse conditions. No statistical differences were detected among the tested doses for this trial.

### Example 13: Evidence of Nematicide Activity of N-09-04 vs Formulation Blank

The objective of this study is to show the nematicide activity of N-09-04 formulation in comparison with blank (matrix of formulation without active ingredient) under controlled conditions, in soil pot with host to control Meloidogyne sp.

This study consists of 2 theses and an untreated control. The juveniles were obtained from a freshly extracted sample of roots of sports turf.

The trial was carried out laboratory under controlled conditions and plant pathogenic nematodes in soil in a volume of 100 ml per pot. The three replicates per treatment were worked in 100 ml pots of soil with 320 plant pathogenic nematodes in each pot.

Results for efficacy values are shown in Table 8. Means followed by the same letter do not significantly differ (P=0.05, Student-Newman-Keuls).

TABLE 8

| | | Lutein (% w/w | |
|---|---|---|---|
| | | of total | Efficacy |
| Product | Dose | composition) | (%) |
| Control untreated | — | 0 | 0.0 a |
| N-09-04 | 5 mL/L | 1.5 | 88.3 b |
| Blank | 5 mL/L | 0 | 4.2 a |

The results showed that N-09-04 had high efficacy, while product blank showed similar values to the untreated control.

### Example 14: Comparative Effectiveness Study Between Products and Raw Materials with Action Nematicide—N-09-04 with and without the Active Ingredient Lutein and Lutein Alone

### Summary:

The purpose of this test was to evaluate the efficacy of the products coded as P1, P2 and P3 of the company IDAI NATURE against a mixture of phytopathogenic nematodes by the company NEVAL.

This study evaluates the behaviour under controlled conditions, in soil (NEPOT test)* of a battery of products against a mixture of phytopathogenic nematodes.

This study consists of 3 compositions, each of them at 2 doses and a control without treatment.

The juveniles were obtained from a freshly extracted sample of roots of sports lawns.

The results showed that products 1 and 3 are the ones that demonstrated the highest efficacy, while product 2 demonstrated similar values to the control without treatment.
NEPOT test: study designed by NEVAL intermediate between pot with donor host in vitro. It is based on pots or glasses with the right amount of 100 mL for a quantification per sample.

### Methodology:

### Identification of the Samples

Product 1: N-09-04—Full formulation
Product 2: Co-formulant package (without A.I.)—(sunflower oil+tensioactives polysorbates 20, 80 and 85+butyl glycol+TBHQ+water)
Product 3: The Active ingredient alone—Lutein

### Treatments

Table 9 shows the treatments applied to the samples.

TABLE 9

| | | | | Moments of | Volume |
|---|---|---|---|---|---|
| Number | Treatment | Dose | | application | application |
| 1 | CONTROL | 0 | | — | 20 mL/pot |
| 2 | Product 1 | 5 | ml/L | T 0 - A | 20 mL/pot |
| 3 | Product 1 | 7.5 | ml/L | T 0 - A | 20 mL/pot |
| 4 | Product 2 | 5 | ml/L | T 0 - A | 20 mL/pot |
| 5 | Product 2 | 7.5 | ml/L | T 0 - A | 20 mL/pot |
| 6 | Product 3 | 0.375 | ml/L | T 0 - A | 20 mL/pot |
| 7 | Product 3 | 0.563 | ml/L | T 0 - A | 20 mL/pot |

The trial was carried out laboratory in Xilxes—Castelon—Spain—under controlled conditions and plant pathogenic nematodes in soil in a volume of 100 mL per pot. The three replicates per treatment were worked in 100 mL pots of soil with 320 plant pathogenic nematodes in each pot.
Pest: Phytopathogenic nematodes (Helicotylenchus and Hemicycliophora)
Innoculum quantity: 320 individuals per experimental unit
Substract: Sandy soil
Application: Manual—20 mL/pot
Design: Randomized Complete Block (RCB)—3 replicates per treatment
Equipment: Manual application: with micropipette and MAT 09.1 balance
Application code: A=28/06/2021—preparation+application A
Extraction=05/07/2021 (7 DAA according Baermann)
Quantification=06/07/2021

### Evaluation

Criteria: Phytotoxicity (0-100) and symptoms description.
0=No visible effects
15=Damage limit
100=Harvest destruction

Table 10 shows the results obtained from all evaluations in an ANOVA table

TABLE 10

| Pest Type | O Other |
|---|---|
| Assessment Date | Jul. 5, 2021 |
| Part Assessed | SOIL - |
| Assessment Type | NEMATODES |
| Assessment Unit/Min/Max | NUMBER -- |
| Number of Subsamples | 1 |
| ARM Action Codes | APC |
| Trt Treatment No. Name | 1 |
| 1 Inoculated Check | 315.0a (0.0%) |
| 2 P1 5 ml/L | 37.0c (88.3%) |
| 3 P1 7.5 ml/L | 37.7c (88.0%) |
| 4 P2 5 ml/L | 301.7a (4.2%) |
| 5 P2 7.5 ml/L | 186.3b (40.8%) |
| 6 P3 0.375 mL/L | 68.0c (78.4%) |
| 7 P3 0.563 ml/L | 71.0c (77.5%) |
| LSD P = .05 | 30.71 |
| Standard Deviation | 17.26 |
| CV | 11.89 |
| Bartlett's X2\hat{ } | 7.517 |
| P(Bartlett's X2) | 0.276 |
| Skewness\hat{ } | −0.8302 |
| Kurtosis\hat{ } | 2.1848* |
| Replicate F | 0.727 |
| Replicate Prob(F) | 0.5036 |
| Treatment F | 150.542 |
| Treatment Prob(F) | 0.0001 |

### Conclusions

The study took place in the NEVAL laboratories located in Xilxes (Castellón—Spain), under the accreditation of Plant Health and Ministry for the realization of studies with phytopathogenic nematodes.

Products 1 (N-09-04 full formulation) and product 2 (the full formulation without the Lutein) were mixed with water, while product 3 (Lutein alone—active ingredient), difficult miscibility was deposited on the ground, adding the water later and mixing everything in the soil with a teaspoon shaking for 30 seconds each replica.

After the study carried out under laboratory conditions, each of the soil samples was extracted using the Baermann funnel procedure for 24 hours and then quantified under a biological microscope.

The Baermann procedure has the particular option of extracting only those individuals that have mobility, that is, that are alive, so the result is extrapolated to living individuals.

In product 1 (N-09-04 full formulation) and product 3 (Lutein alone—active ingredient) there was a lower recovery of individuals and a similarity in results without statistical differences between doses or between them, so its effect “-cidal” (or killing effect) is evident, while product 2 (the full formulation without the Lutein) at low dose obtained a population similar to the control without treatment and at high dose had a slight decrease in the recovery of juveniles.

It can be concluded that the product 1 (N-09-04 full formulation) shows a control of 88.3% and 88.0% significantly better than the product 3 (Lutein alone—active ingredient) that shows a control of 78.4% and 77.5%. In the opposite way it is clear that the package of formulation without the active ingredient have a low or even no contribution to the “-cidal” effect (or killing effect) of the final product, where product 3 shows a control of 4.2% and 40.8% respectively (not consistent and replicable).

### Example 15: Comparative Field Trial for the Control of Pratylenchus Brachyurus in Sweet Potato Cultivated Open Field Using N-09-04 vs. Commercial Reference

Plant-parasitic nematodes in the genus Pratylenchus are commonly called lesion nematodes. Lesion nematodes are plant parasitic nematodes that damage the host plants by infesting roots. Lesion nematodes are migratory endoparasites that feed and reproduce in the root.

Pratylenchus brachyurus can infest a wide range of crops. Potato, peanuts, pineapple, soybeans, sugar cane, tomatoes, citrus, and cotton are just a few of the crops it can infest.

The purpose of this study was to evaluate the efficacy and crop safety of N-09-04 applied through drip irrigation in the root zone. The trial was conducted on sweet potato plants cultivated open field according to standard commercial practices and artificially infested with Pratylenchus brachyurus. The trial was carried out in Morrinhos (Goias, Brazil). A commercial bionematicide was selected as reference (Quartzo®, FMC) and a commercial traditional chemical pesticide also was used as reference (Nimitz® EC, Adama). For all the treatments, eight applications were made using the drip irrigation system, table 11 shows the products and applications rates and table 12 shows the timing of applications.

TABLE 11

| | A.I. - Concentration - | Dose | Application |
|---|---|---|---|
| Treatment name | Formulation type | rate | code |
| Untreated control (UTC) | — | — | — |
| N-09-04 | Lutein 1.5% w/w | 3 L/ha | ABCDEFGH |
| N-09-04 | Lutein 1.5% w/w | 4 L/ha | ABCDEFGH |
| NIMITZ ® + | Fluensulfone - 480 g/L EC | 1 L/ha | B |
| N-09-04 | Lutein 1.5% w/w | 3 L/ha | CEGH |
| NIMITZ ® | Fluensulfone - 480 g/L EC | 1 L/ha | B |
| QUARTZO ® | Bacillus subtilis (Min. | 130 g/ha | ABCDEFGH |
| | 1011 CFU/g) + Bacillus | | |
| | licheniformis (Min. 1011 | | |
| | CFU/g) - WP | | |

TABLE 12

| Application | Application | Application | Application |
|---|---|---|---|
| code | timing | date | method |
| A | 21 days before planting | 3 Jun. 2022 | Drip irrigation |
| B | 21 DAA at planting | 24 Jun. 2022 | Drip irrigation |
| C | 25 DAB | 19 Jul. 2022 | Drip irrigation |
| D | 7 DAC | 26 Jul. 2022 | Drip irrigation |
| E | 7 DAD | 2 Aug. 2022 | Drip irrigation |
| F | 7 DAE | 9 Aug. 2022 | Drip irrigation |
| G | 7 DAF | 16 Aug. 2022 | Drip irrigation |
| H | 21 DAG | 6 Sep. 2022 | Drip irrigation |

The trial was implemented using a Randomized Complete Block design with 4 replications and individual plot of 4 rows of 5 meters long (0.7m between the rows) for a total of 14 m² with a planting density of 4 tubers/meter.

The applications of all products under test were conducted through the drip irrigation system on the planting row (products applied directly to the root zone).

The artificial infestation with Pratylenchus brachyurus was performed on the 02/08/2022, 39 days after planting (7 days after application D (7 DAD)).

The following assessments were performed throughout the trial:
a) Nematode counts in soil: Soil samples were collected in the root zone and analyzed in the laboratory to determine the number of J2/150 cm3 of soil.
b) Nematode counts in tubers: At harvest (110 days after planting—36 days after application H), tuber samples were collected and analyzed in the laboratory to determine the number of J2+eggs/g of tuber peel.
c) Tuber production (yield) was measured at harvest in each plot and expressed as total yield in Ton/ha.
d) The harvested tubers were ranked according to 5 tuber size categories:
   Tubers<28 mm
   Tubers between 28 and 33 mm
   Tubers between 33 and 42 mm
   Tubers between 42 and 70 mm
   Tubers>70 mm
e) Phytotoxicity was assessed visually according to % of severity

The results obtained with each of the main variables recorded in the trial are presented hereunder.

### Nematode (J2) Population in Soil:

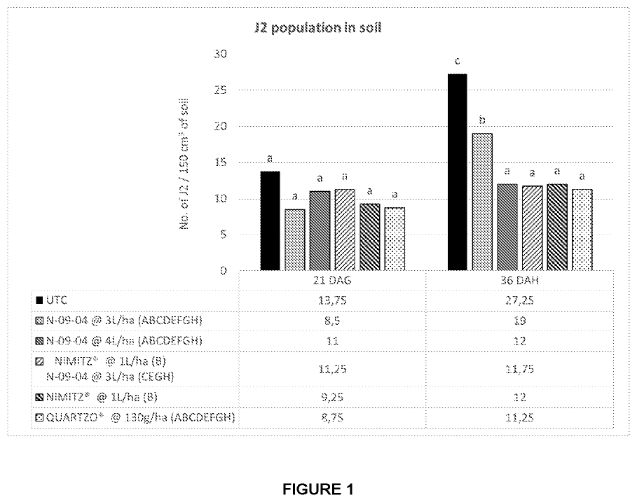

FIG. 1 shows the J2 nematode population (number of J2/150 cm3 of soil) counted in the soil samples collected 21 days after application G (21 DAG) and at harvest (36 days after application H (36 DAH)).

At the 1st assessment date, all treatments presented a statistically similar J2 population in soil.

At harvest, significant differences were observed between the treatments. All products applied significantly reduced the J2 population in soil compared to the control. The lowest number of J2 were recorded in plots treated with N-09-04 at 4 L/ha (treatment 3), NIMITZ® followed by N-09-04 applications at 3 L/ha (treatment 4), NIMITZ® and QUARTZO® applied standalone (treatments 5 and 6) without any statistical differences between them.

### Nematode (Eggs+J2) Population in Tuber Peel:

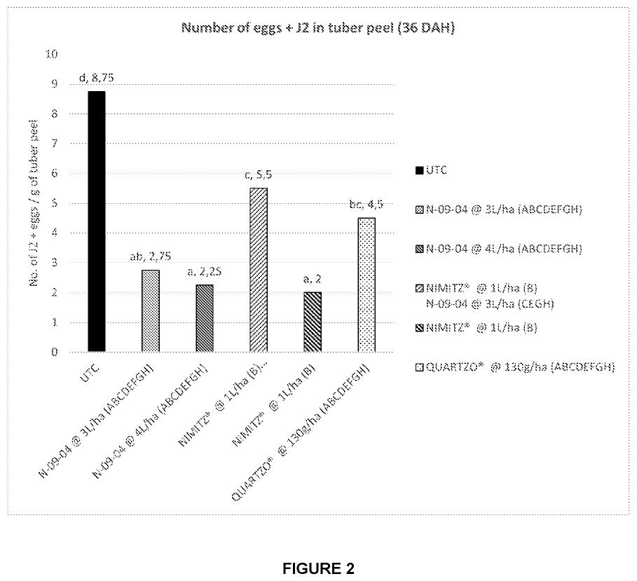

FIG. 2 presents the number eggs+J2 (number of eggs+J2/g of tuber peel) counted in the tuber samples collected at harvest (110 after planting—36 days after application H (36 DAH)).

A significant reduction of the number of J2+egg in tuber peel was observed for all treated objects compared to the control. The lowest numbers of J2+eggs were recorded in plot treated with N-09-04 applied at 3 L/ha and N-09-04 at 4 L/ha (treatment 2 and 3) and NIMITZ® applied standalone (treatment 5) without any statistical differences between them.

### Tuber Production:

At harvest (110 after planting—36 days after application H (36 DAH)), the total tuber production was recorded for each treatment.

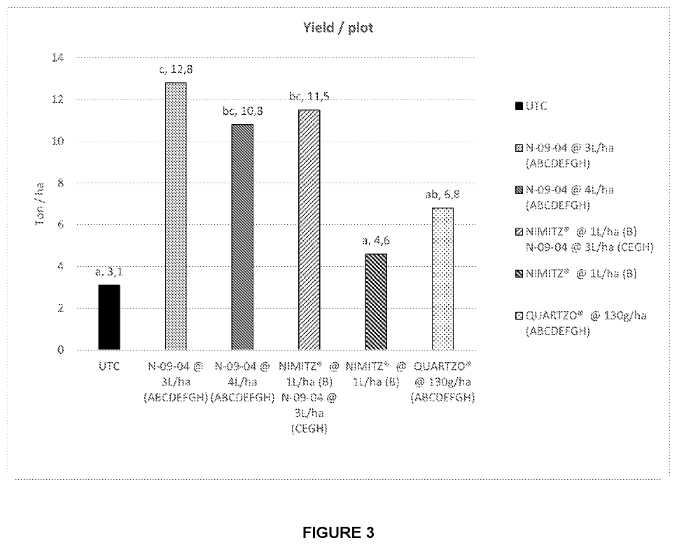

FIG. 3 presents the total tuber yield in the different treatments (expressed in Ton/ha).

All treated objects presented a significantly higher yield compared to the control. The highest yield levels were recorded in plots treated with N-09-04 at 3 L/ha and N-09-04 at 4 L/ha (treatments 2 and 3) and NIMITZ® followed by N-09-04 applications at 3 L/ha (treatment 4) without significant differences between them.

### Tuber Grading:

At the end of the trial, the harvested tubers were ranked in 5 size categories.

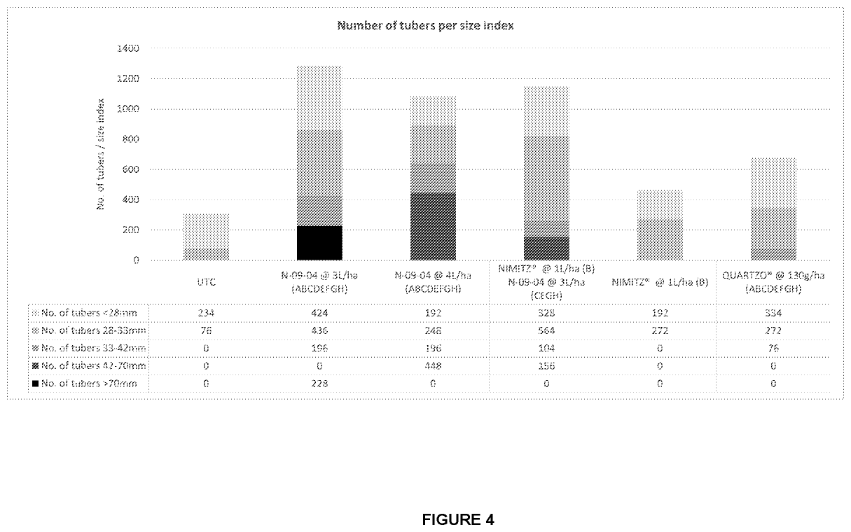

FIG. 4 presents the number of tubers/size index harvested in the different treatments.

Coherently with the yield data presented above, a substantially higher number of tubers were harvested in plot treated with N-09-04 at 3 L/ha and N-09-04 at 4 L/ha (treatments 2 and 3) and NIMITZ® followed by N-09-04 applications at 3 L/ha (treatment 4) compared to the control.

The best tuber grading profile was recorded in plots applied with N-09-04 at 3 L/ha (treatment 2).

### Phytotoxicity:

No phytotoxic effects were observed with any of the products during the trial.

### Conclusions

This trial conducted in open field sweet potato with artificial infestation of Pratylenchus brachyurus confirmed the nematode control effects of the compositions according to the invention, particularly nematicide activity of compositions made according to the present invention, notably the formulation N-09-04 against this nematode species.

Application of N-09-04 (Lutein 1.5% w/w) at 3 and 4 L/ha to the crop root zone resulted in:
A) A significant reduction of the nematode J2 populations in the soil at harvest;
B) A significant reduction of the number of eggs+J2 in the tuber peel at harvest;
C) A significant increase of the total sweet potato production in quantity (Ton/ha) and quality (tuber grading profile).

Applications of N-09-04 containing Lutein at 1.5% w/w (all rates and timings considered) were safe to the crop and did not induce any kind of phytotoxicity.

### Example 16: Comparative Field Trial for the Control of Meloidogyne incognita in Tomato Cultivated in Greenhouse Using N-09-04 vs. Commercial Reference

Plant-parasitic nematodes in the genus Meloidogyne are commonly called root-knot nematodes. Root-knot nematodes are plant parasitic nematodes that damage the host plants by infesting roots. Root knot nematodes do not kill the tissue but cause the development of vascular tissue around the feeding area to enlarge and produce “giant cells.” The formation of giant cells is solely to benefit the nematode and provide the necessary nutrition for the nematode growth and subsequent production of large numbers of eggs. The root begins to swell in this area and continues to enlarge (creating a gall) as the nematodes complete their larval stages and become adults. Root-knot nematodes overwinter in the soil as eggs or juveniles. The juveniles can infect roots, and the eggs will hatch whenever soil becomes warm.

Feeding by these nematodes reduces root and plant vigor, causes lesions, and predisposes plants to infection by soil-dwelling diseases. Meloidogyne have a very broad host spectrum and can infect more than 2000 plants worldwide causing approximately 5% of global crop loss.

The purpose of this study was to evaluate the efficacy and crop safety of N-09-04 applied through drenching (manual application with a watering can) in the root zone. The trial was conducted on tomato plants cultivated under greenhouse according to standard commercial practices. The trial was performed on a natural population of Meloidogyne incognita (an initial counting of the J2 population in soil was performed before the start of the trial to ensure a sufficient and homogenous nematode population across the plots).

The trial was carried out in Itaara (Rio Grande do Sul, Brazil). A commercial bionematicide was selected as reference (Quartzo®, FMC) and a commercial traditional chemical pesticide also was used as reference (Nimitz® EC, Adama). For all the treatments, nine applications were made using a manual drenching to the root zone, table 13 shows the products and applications rates and table 14 shows the timing of applications.

TABLE 13

| | A.I. - Concentration - | Dose | Application |
|---|---|---|---|
| Treatment name | Formulation type | rate | code |
| Untreated control (UTC) | — | — | — |
| N-09-04 | Lutein 1.5% w/w | 3 L/ha | BCDEFGHI |
| N-09-04 | Lutein 1.5% w/w | 4 L/ha | BCDEFGHI |
| NIMITZ ® + | Fluensulfone - 480 g/L EC | 1 L/ha | A |
| N-09-04 | Lutein 1.5% w/w | 3 L/ha | FGHI |
| NIMITZ ® | Fluensulfone - 480 g/L EC | 1 L/ha | A |
| QUARTZO ® | Bacillus subtilis (Min. | 200 g/ha | BCDEFGHI |
| | 1011 CFU/g) + Bacillus | | |
| | licheniformis (Min. 1011 | | |
| | CFU/g) - WP | | |

TABLE 14

| Application | Application | Application | Application |
|---|---|---|---|
| code | timing | date | method |
| A | 7 days before | 2 Feb. 2022 | Drenching |
| | transplanting | | |
| B | 6 DAA at | 8 Feb. 2022 | Drenching |
| | transplanting | | |
| C | 7 DAB | 19 Jul. 2022 | Drenching |
| D | 7 DAC | 15 Feb. 2022 | Drenching |
| E | 14 DAD | 22 Feb. 2022 | Drenching |
| F | 14 DAE | 8 Mar. 2022 | Drenching |
| G | 14 DAF | 22 Mar. 2022 | Drenching |
| H | 14 DAG | 5 Apr. 2022 | Drenching |
| I | 14 DAH | 19 Apr. 2022 | Drenching |

The trial was implemented using a Randomized Complete Block design with 6 replications and individual plot of 10 m² or a total of 20 plants/plot.

The applications of all products under test were conducted manually by drenching with a watering can on the planting row (products applied directly to the root zone).

The following assessments were performed throughout the trial:
a) Crop vigor (visually assessed according to a 1-9 index on a whole plot basis):
   Index 1: low crop vigor
   Index 9: high crop vigor
b) Crop height (expressed in cm) was measured between the soil and the active growing point of plants.
c) Fresh weight (expressed in g) of the aerial parts and entire root systems (destructive assessment) were measured by cutting the plants at the collet and weighting separately the aerial parts (foliage) and underground parts (washed root system).
d) Nematode counts in soil: Composite soil samples were collected at depths of 0-30 cm for a total of approximately 1 Kg of soil. Soil samples were analyzed in the laboratory to determine the number of J2 and eggs/200 cm3 of soil.
e) Nematode counts in roots: Composite root samples were collected at depths of 0-30 cm for a total of approximately 30-50 g of roots. Root samples were analyzed in the laboratory to determine the number of J2 and eggs/g of roots.
f) Fruit production (yield) was measured on a total of 10 plants/plot and expressed as:
   Total yield in Kg/ha
   Total number of fruits/plot
g) Fruit sugar content (expressed in ° Brix) was measured using a refractometer on a sample size of 2 fruits/plot.
h) Phytotoxicity was assessed visually according to % of severity

The results obtained with each of the main variables recorded in the trial are presented hereunder.

### Crop Vigor:

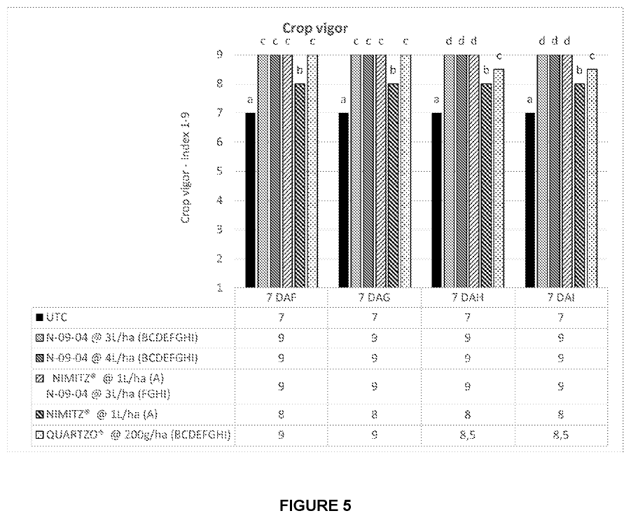

FIG. 5 shows the bar plot showing the crop vigor in the different treatments, and it presents the crop vigor data generated at 4 different assessment dates throughout the trial:
7 DAF: 7 days after application F
7 DAG: 7 days after application G
7 DAH 7 days after application H
7 DAI: 7 days after application I

All treated objects presented significantly higher crop vigor values compared to the control plants. The highest crop vigor values were recorded with N-09-04 at 3 L/ha and N-09-04 at 4 L/ha (treatments 2 and 3) and NIMITZ® applied in a sequence with N-09-04 at 3 L/ha (treatment 4).

### Crop Height:

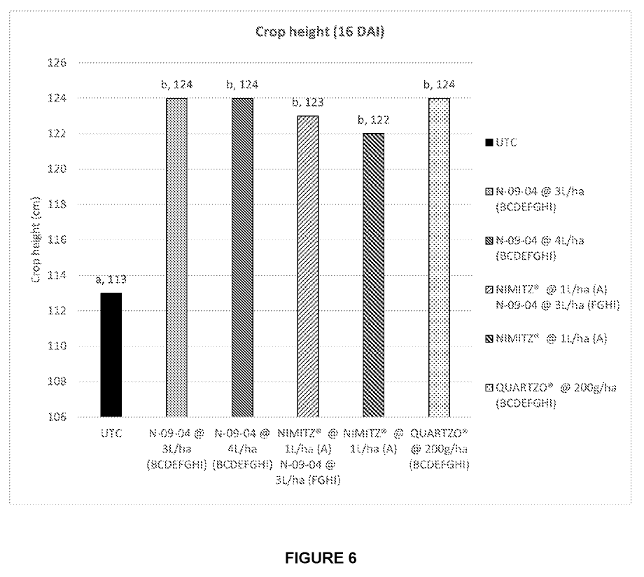

FIG. 6 presents the crop height data recorded 16 days after application 1 (16 DAI).

All treated objects presented significantly higher crop heights compared to the control. The highest crop height values were recorded with N-09-04 at 3 L/ha and N-09-04 at 4 L/ha (treatments 2 and 3) and QUARTZO® (treatment 6).

### Plant Fresh Weight—Aerial Parts:

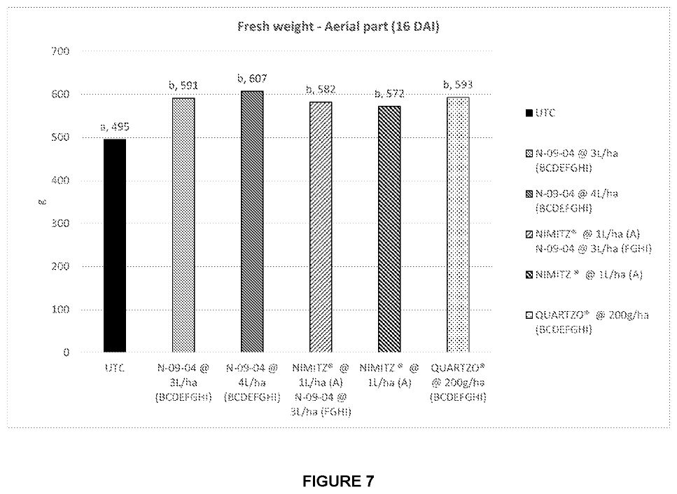

FIG. 7 presents the aerial part fresh weight data recorded 16 days after application 1 (16 DAH).

All treated objects presented significantly higher aerial part fresh weight compared to the control. The highest aerial part fresh weight values were recorded with N-09-04 at 4 L/ha (treatment 3) without significant differences with the other treated objects.

### Plant Fresh Weight—Root System:

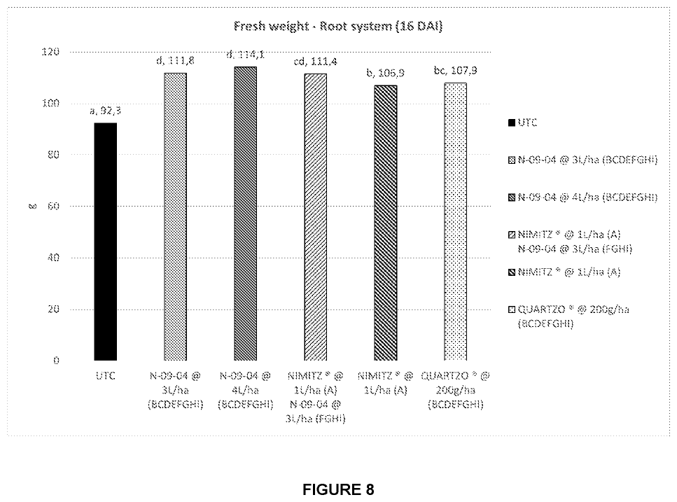

FIG. 8 presents the fresh root weight data recorded 16 days after application I (16 DAI). All treated objects presented significantly higher root fresh weight compared to the control. Plants treated with N-09-04 at 3 L/ha and N-09-04 at 4 L/ha (treatments 2 and 3) and NIMITZ® applied in a sequence with N-09-04 at 3 L/ha (treatment 4) presented the highest root fresh weight values without significant differences between them.

### Nematode (J2) Population in Soil:

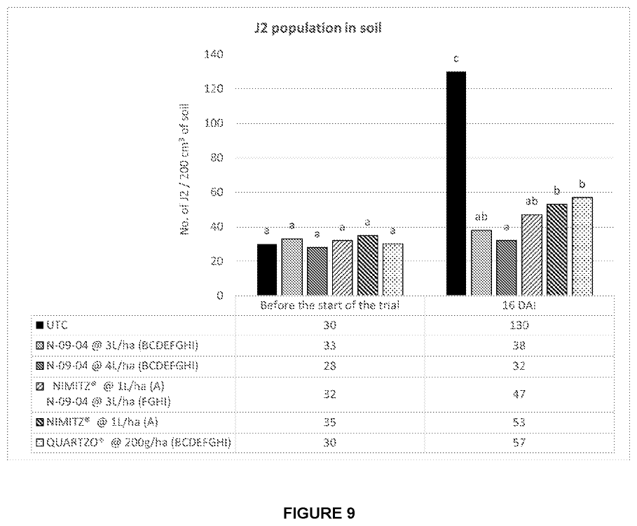

FIG. 9 shows the J2 nematode population (number of J2/200 cm3 of soil) counted in the soil samples collected before the start of the trial and 16 days after application I (16 DAI).

The initial J2 population recorded at the start of the trial was homogeneous across all treatments.

Sixteen days after application I (16 DAI), a significant reduction of the J2 population in soil was observed for all treated objects. The lowest J2 populations were recorded in plot treated with N-09-04 applied at 3 L/ha and N-09-04 at 4 L/ha (treatment 2 and 3) and NIMITZ® applied in a sequence with N-09-04 at 3 L/ha (treatment 4) without any statistical differences between them.

### Nematode (Eggs) Population in Soil:

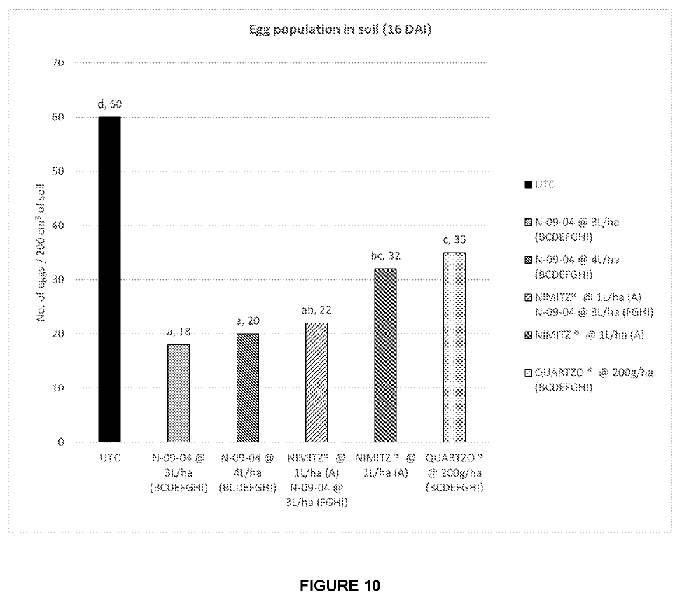

FIG. 10 shows the eggs population (number of eggs/200 cm3 of soil) counted in the soil samples collected 16 days after application I (16 DAI).

A significant reduction of the egg population in soil was observed for all treated objects. The lowest numbers of eggs were recorded in plot treated with N-09-04 applied at 3 L/ha and N-09-04 at 4 L/ha (treatment 2 and 3) and NIMITZ® applied in a sequence with N-09-04 at 3 L/ha (treatment 4) without any statistical differences between them.

### Nematode (J2) Population in Roots:

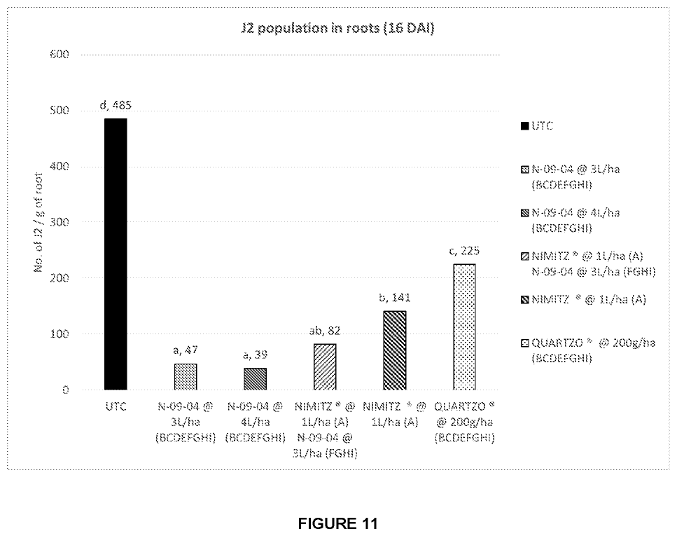

FIG. 11 shows the J2 nematode population (number of J2/g of roots) counted in the root samples collected 16 days after application I (16 DAI).

A significant reduction of the J2 population in roots was observed for all treated objects. The lowest J2 populations were recorded in plot treated with N-09-04 applied at 3 L/ha and N-09-04 at 4 L/ha (treatment 2 and 3) and NIMITZ® applied in a sequence with N-09-04 at 3 L/ha (treatment 4) without any statistical differences between them.

### Nematode (Eggs) Population in Roots:

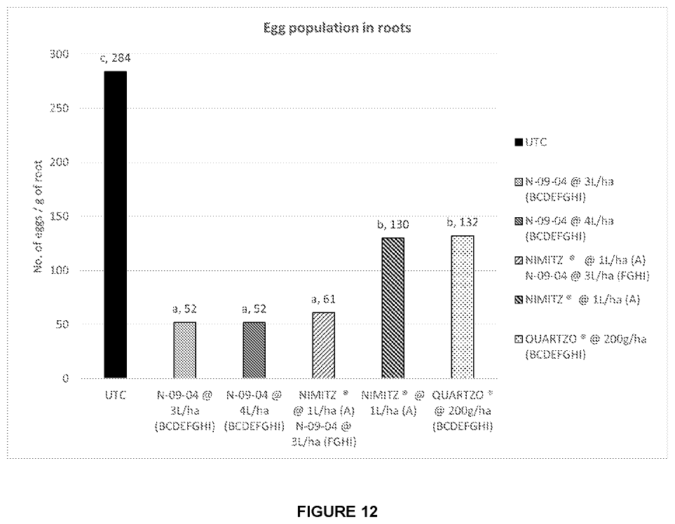

FIG. 12 shows the eggs population (number of eggs/g of roots) counted in the root samples collected 16 days after application I (16 DAI).

A significant reduction of the egg population in roots was observed for all treated objects. The lowest numbers of eggs were recorded in plot treated with N-09-04 applied at 3 L/ha and N-09-04 at 4 L/ha (treatment 2 and 3) and NIMITZ® applied in a sequence with N-09-04 at 3 L/ha (treatment 4) without any statistical differences between them.

### Fruit Production:

At the end of the trial, the total tomato production was recorded for each treatment.

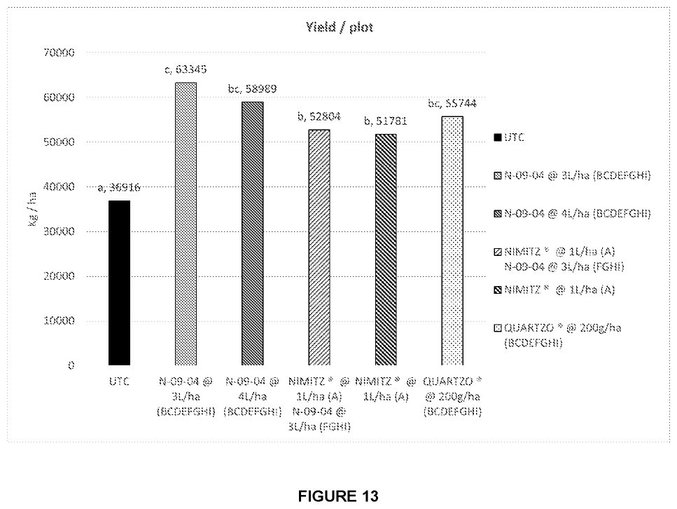

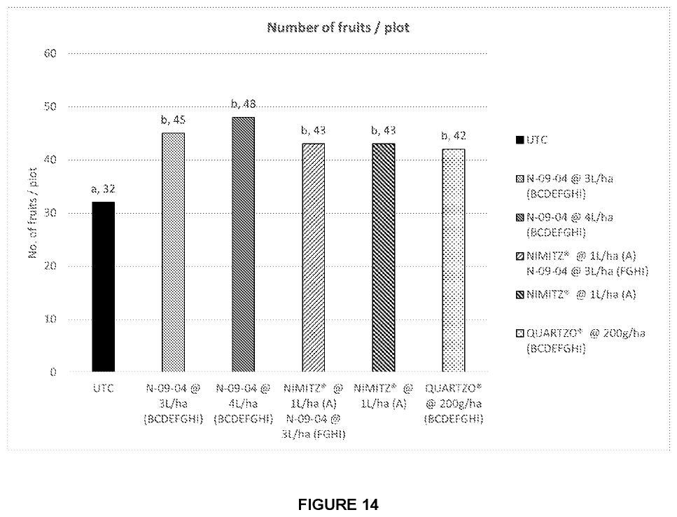

FIG. 13 and FIG. 14 show the different parameters recorded to evaluate the tomato production:
A) FIG. 13 presents the total number of fruits harvested in the different treatments (expressed in Number of fruits/plot)
B) FIG. 14 presents the total production (Yield) of the different treatments in Kg/ha

Regarding the total number of fruits produced, all treated plots presented a significantly higher number of fruits compared to the control. The highest number of fruits produced was recorded in plots treated with N-09-04 at 4 L/ha (treatment 3) without any statistical differences with the other treated plots.

Regarding the yield per plot, all treated plots presented a significantly higher yield compared to the control. The highest yield levels were recorded in plots treated with N-09-04 at 3 L/ha and N-09-04 at 4 L/ha (treatments 2 and 3) and QUARTZO® (treatment 6) without significant differences between them.

### Fruit Quality (Sugar Content):

At the end of the trial, the fruit sugar content was measured for each treatment.

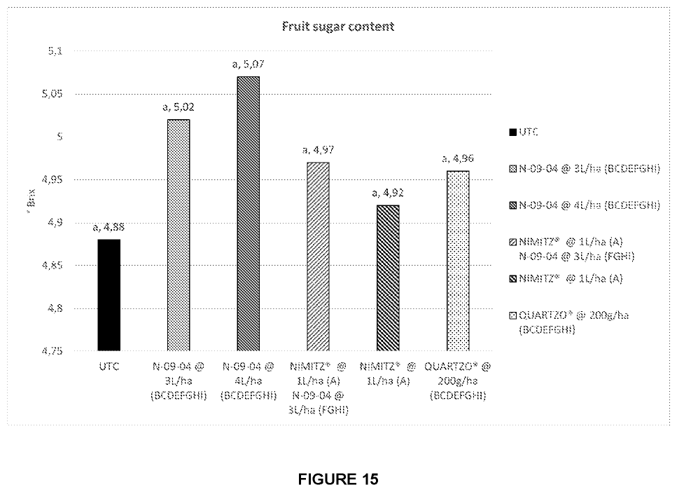

FIG. 15 presents the sugar content (in ° Brix) of the fruits harvested in the different treatments.

No significant differences of sugar content were recorded between the treatments. These results highlights that the gain of production observed on the yield and number of fruits variables were not detrimental to the fruit quality.

### Phytotoxicity:

No phytotoxic effects were observed with any of the products during the trial.

### Conclusions

This trial conducted in greenhouse tomato with natural infestation of Meloidogyne incognita confirmed the nematicide activity of a product made according to this invention, notably N-09-04 against the pest nematode Meloidogyne incognita.

Application of N-09-04 Lutein at 1.5% at 3 and 4 L/ha to the crop root zone resulted in:

A) A significant improvement of the Crop vigor compared to the control and the commercial standard references applied standalone.

B) A significant improvement of the Crop height compared to the control.

C) A significant improvement of the Fresh weight, of both aerial and root systems, compared to the control. Regarding the fresh root weight, N-09-04 Lutein at 1.5% at 3 and 4 L/ha presented significantly higher root weight compared to the commercial standard references applied standalone.

D) A significant reduction of the nematode J2 and eggs populations in the soil and in the roots. At the final assessment date, N-09-04 Lutein at 1.5% at 3 and 4 L/ha presented significantly lower number of J2 and eggs (in both soil and roots) compared to the commercial standard references applied standalone.

E) A significant increase of the total tomato production in quantity (Kg/ha) and number of fruits compared to the control while maintaining the same fruit quality (fruit sugar content).

Applications of N-09-04 Lutein at 1.5% (all rates and timings considered) were safe to the crop and did not induce any kind of phytotoxicity.

### Example 18: Comparative Lab Trials Comparing Antioxidant Agents Protecting the Active Ingredient Carotenoid from Temperature, pH and Oxygen Oxidation

The objective of this study is to compare performance of different types of antioxidant agents protecting the active ingredient against variation of temperature, pH (7 and 9) and also oxidation by the oxygen from the atmosphere.

The lab test was done using the formulation N-09-04 as a base, changing the antioxidant TBHQ (N-09-04 formula) for Tocopherol (N-09-04-a formula) or propyl galate (N-09-04-b): N-09-04: Composition that contains the lutein (1.50% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant I (0.7% w/w of total composition) acting as an UV light protector, and
water (41.8% w/w of total composition)

N-09-04-a: Composition that contains the lutein (1.50% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant Tocopherol (0.7% w/w of total composition) acting as an UV light protector, and
water (41.8% w/w of total composition)

N-09-04-b: Composition that contains the lutein (1.50% w/w of total composition) dispersed in sunflower oil (6% w/w of total composition), and mixed with:
three tensioactives polysorbate E20 (15% w/w of total composition), polysorbate E80 (15% w/w of total composition) and polysorbate E85 (15% w/w of total composition),
the solvent butyl glycol (5% w/w of total composition) acting as a dispersant,
the antioxidant TBHQ (0.7% w/w of total composition) acting as an UV light protector, and
water (41.8% w/w of total composition) The pH was achieved using triethanolamine or citric acid in an enough amount to reach the pH of 7 or pH of 9 for each formulation.

### Methodology

The principle of the test was to evaluate how temperature, pH of the formulation and the oxygen inside the package will affect or not the degradation of the carotenoid inside the bottle.

Bottles of 1 liter containing 500 mL (half-filled) and 1 liter (full filled) of each formulation and in each pH was placed in an oven with a controlled temperature of 54° C. Other set of bottles containing 500 mL and 1 liter was placed in a room with temperature controlled at 20° C. The test was performed for 14 days (Arrhenius test).

The assay of Lutein was analysed at time zero in each bottle of each formulation.

Table 15 shows the tested antioxidant formulations prepared for this set of evaluations at time zero. All formulations present as a single-phase appearance.

TABLE 15

Product

| | Lutein | Lutein | |
|---|---|---|---|
| | (% w/w) | (% w/w) | |
| Time 0 | pH 7 | pH 9 | Appearance |
| N-09-04 | 1.400 | 1.445 | Dark Brown |
| Lutein (TBHQ) | | | single phase |
| N-09-04-a | 1.442 | 1.447 | Dark Brown |
| Lutein (Tocopherol) | | | single phase |
| N-09-04-b | 1.393 | 1.330 | Dark Brown |
| Lutein (propyl galate) | | | single phase |

Table 16 shows the results of decreased concentration of Lutein considering the formulation tested.

TABLE 16

| | | N-09-04a | N-09-04-a | N-09-04-b | N-09-04-b | N-09-04 | N-09-04 |
|---|---|---|---|---|---|---|---|
| | | Tocopherol | Tocopherol | propyl | propyl | TBHQ | TBHQ |
| | 15 days | 0.7% | 0.7% | galate 0.7% | galate 0.7% | 0.7% | 0.7% |
| Package type | temp. | pH 7 | pH 9 | pH 7 | pH 9 | pH 7 | pH 9 |
| Initial | | 1,442 | 1,447 | 1,393 | 1,330 | 1,400 | 1,445 |
| Concentration of Lutein | | | | | | | |
| Half bottle | 20° C. | 94 | 89 | 90 | 99 | 99 | 97 |
| Full bottle | 20° C. | 97 | 92 | 98 | 100 | 100 | 97 |
| Half bottle | 54° C. | 83 | 83 | 81 | 95 | 94 | 98 |
| Full bottle | 54° C. | 94 | 89 | 95 | 100 | 99 | 99 |

The results show that all formulations/compositions are physical-chemical stable under accelerated shelf-life conditions in room temperature of 20° C. The terc-butyl hydroquinone (TBHQ) was confirmed as the best antioxidant slightly better than propyl galate and tocopherol.

The oxidation by oxygen (half-filled bottle) and the high pH only affected tocopherol performance (89% of final assay of lutein) in room temperature of 20° C.

The results show that terc-butyl hydroquinone (TBHQ) formulations/compositions are physical-chemical stable under accelerated shelf-life conditions in heat temperatures of 54° C., considering 14 days.

The propyl galate have less efficacy, slightly worse than TBHQ because the oxidation by oxygen in both pHs evaluated.

The tocopherol has less efficacy because oxidation by oxygen and also in high pH of 9.

The full filled bottle is confirmed as better in terms of protection against oxygen oxidation than a half-filled bottle, mainly in height temperatures.

The tests confirmed that all three antioxidants can be used to protect carotenoids, with the terc-butyl hydroquinone having a better performance than other compounds tested.

### Example 19: Comparative Lab Trials Using Mixture of Carotenoids Vs Formulation Blank

The objective of this study is to produce mixture of carotenoids and show the nematicide activity of some formulation in comparison with blank (matrix of formulations without active ingredient) under controlled conditions, in petri dish and in soil pot with host to control Meloidogyne sp. and other selected species of nematodes.

Table 17 shows the test mixtures prepared for this set of evaluations at time zero. All formulations present as a single-phase appearance.

TABLE 17

| | Density | pH | Emulsion stability |
|---|---|---|---|
| Product | (g/mL) | (1% v/v) | (CIPAC D water - 5% v/v) |
| C-10-32 | 1.046 | 8.91 | Complete |
| Lutein + | | | |
| Apocarotenal | | | |
| C-10-29 | 1.052 | 8.84 | 0.5 ml of |
| Lutein + | | | creme on top |
| Lycopene | | | |
| C-10-31 | 1.049 | 9.03 | 0.5 ml of |
| Lycopene + | | | creme on top |
| Beta-carotene | | | |
| C-10-30 | 1.055 | 8.96 | 0.5 ml of |
| Lycopene + | | | creme on top |
| Apocarotenal | | | |
| C-10-33 | 1.051 | 9.09 | Complete |
| Beta-carotene + | | | |
| Apocarotenal | | | |
| C-10-34 | 1.050 | 8.75 | Complete |
| Lycopene + | | | |
| Astaxanthin | | | |

Table 18 shows the test mixtures prepared for this set of evaluations at 15 days at 54° C.—accelerated stability test. No phase separation was observed in all products.

TABLE 18

| | Density | pH | Emulsion stability |
|---|---|---|---|
| Product | (g/mL) | (1% v/v) | (CIPAC D water - 5% v/v) |
| C-10-32 | 1.044 | 8.57 | Complete |
| Lutein + | | | |
| Apocarotenal | | | |
| C-10-29 | 1.051 | 8.55 | 1 ml of |
| Lutein + | | | creme on top |
| Lycopene | | | |
| C-10-31 | 1.046 | 8.63 | 1 ml of |
| Lycopene + | | | creme on top |
| Beta-carotene | | | |
| C-10-30 | 1.053 | 8.41 | 1 ml of |
| Lycopene + | | | creme on top |
| Apocarotenal | | | |
| C-10-33 | 1.048 | 8.82 | 0.5 mL of |
| Beta-carotene + | | | creme on top |
| Apocarotenal | | | |
| C-10-34 | 1.049 | 8.53 | Traces of |
| Lycopene + | | | creme on top |
| Astaxanthin | | | |

The results shown that all formulations/compositions are physical-chemical stable under accelerated shelf-live conditions.

Without being limited to theory, the Applicant submits that it is the compositions according to this invention show nematode control. Nematode control is shown over a period of time suggesting the unique components together provide for anti-degradation of carotenoids within the composition. The compositions not only show nematistatic and/or nematicidal activity but also shows effects against reproductive and feeding capacity of nematodes. The compositions themselves and the use of the compositions in nematode control could not have been predicted upon fair review of the prior art, nor is there any suggestion or motivation in the prior art.

The Applicant submits that the disclosure herein ameliorates disadvantages known from the prior art.

While the invention has been described in detail with respect to specific embodiments and/or examples thereof, it will be appreciated that those skilled in the art, upon attaining an understanding of the foregoing may readily conceive of alterations to, variations of and equivalents to these embodiments. Accordingly, the scope of the present invention should be assessed as that of the claims and any equivalents thereto, which claims are appended hereto.

1. A method of controlling nematodes, comprising contacting the nematodes with a composition which comprises one or more carotenoids comprising carotenoids selected from the group consisting of:
beta carotene, lutein, astaxanthin, lycopene, zeaxanthin and apocarotenal; and a dispersant selected from the group consisting of: (C₂-C₁₂) alcohols, ethanol, isopropanol, n-octanol, 2 ethyl-hexanol, glycerin, glycerol, (C₂-C₃₀) alkene glycol, dipropylene glycol, polypropylene glycol, butyl glycol or alkyl ethers thereof, sorbitol, mannitol, dulcitol, ethyl lactate, butyl lactate, and 2-ethylhexyl lactate.

2. The method according to claim 1, wherein the carotenoids are dispersed in a vegetable carrier selected from the group consisting of:
sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils.

3. The method according to claim 2, wherein the carrier is sunflower oil.

4. The method according to claim 3, wherein the composition further comprises one or more tensioactives, wherein the tensioactives are nonionic and/or anionic tensioactives, wherein the nonionic tensioactives are selected from the group consisting of: alkoxylated sorbitan fatty esters, ethoxylated sorbitan fatty esters, ethoxylated sorbitol fatty esters, polysorbate E20, polysorbate E80, polysorbate E85, ethoxylated fatty acids, ethoxylated fatty alcohols, ethoxylated and propoxylated fatty acids, ethoxylated and propoxylated fatty alcohols, lecithin, graft acrylic copolymers, and alkyl polyglucoside; and wherein the anionic tensioactives are selected from the group consisting of: alkyl benzene sulfonic acid salts, alkyl ether sulfates, alkyl ethoxylated ether sulfates, alkyl polyglycol ether phosphates, alkyl phosphate esters, lignosulfonates, naphthalene sulfonates, ethoxylated tristyrylphenol phosphates, random acrylic copolymers, and combinations thereof.

5. (canceled)

6. The method according to claim 4, wherein the tensioactives are polysorbate E20, polysorbate E80 and polysorbate E85.

7. The method according to claim 5, wherein the composition further comprises an additive selected from the group consisting of:
preservatives, humectant, wetting agents, spreaders, compatibilizers, binders, fillers, adhesives, protective colloids, thickeners, thixotropic agents, penetrants, retention promoters, sequestrants, clarifiers, anti-freezing agents, anti-caking agents, hydrotropes, stabilizers, antioxidants, UV-light protectors, acidifiers, alkaline agents, chelates, complexing agents, dyes, rheology modifiers, antifoams, anti-drift agents, and combinations thereof.

8. The method according to claim 6, wherein the additive is an antioxidant selected from the group consisting of:
butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and combinations thereof.

9. The method according to claim 1, wherein the carotenoid is beta-carotene dispersed in a carrier of sunflower oil;
the tensioactives consist of polysorbate E20, polysorbate E80 and polysorbate E85;
a dispersant which is butyl glycol;
an antioxidant which is TBHQ; and
water.

10. The method according to claim 1, wherein the carotenoid is astaxanthin dispersed in a carrier of sunflower oil;
the tensioactives consist of polysorbate E20, polysorbate E80 and polysorbate E85;
a the dispersant is butyl glycol;
the antioxidant is TBHQ; and
water.

11. (canceled)

12. The method according to claim 1, wherein the carotenoid is lycopene dispersed in a carrier of sunflower oil;
the tensioactives consist of polysorbate E20, polysorbate E80 and polysorbate E85;
the dispersant is butyl glycol;
an the antioxidant is TBHQ; and
water.

13. The method according claim 1, wherein the nematode is of the genus Heterodera, Globodera, Meloidogyne, Radopholus, Rotylenchus, Pratylenchus, Tylenchulus, Telotylenchus, Tylenchorhynchus, Helicotylenchus Longidorus, Trichodorus, Xiphinema, Ditylenchus, Aphelenchoides or Anguina combat.

14. (canceled)

15. (canceled)

16. (canceled)

17. A nematode control composition comprising:
one or more carotenoids selected from the group consisting of: beta carotene, lutein, astaxanthin, lycopene, zeaxanthin and apocarotenal; and
a dispersant selected from the group consisting of: (C₂-C₁₂) alcohols, ethanol, isopropanol, n-octanol, 2 ethyl-hexanol, glycerin, glycerol, (C₂-C₃₀) alkene glycol, dipropylene glycol, polypropylene glycol, butyl glycol or alkyl ethers thereof, sorbitol, mannitol, dulcitol, ethyl lactate, butyl lactate, and 2-ethylhexyl lactate a carrier dispersing the carotenoids therein, wherein the carrier is a vegetable carrier selected from the group consisting of: sunflower oil, corn oil, safflower oil, sunflower oil, soybean oil, avocado oil, jojoba oil, pumpkin oil, grapeseed oil, sesame oil, hazelnut oil, tall oil fatty acid, methyl seed oil ester, ethyl seed oil ester, methyl fatty acid ester, ethyl fatty acid ester, glycerol oil and glycerine vegetable ester oils;
one or more tensioactives selected from nonionic and/or anionic tensioactives, wherein the nonionic tensioactives are selected from the group consisting of alkoxylated sorbitan fatty esters, ethoxylated sorbitan fatty esters, ethoxylated sorbitol fatty esters, polysorbate E20, polysorbate E80, polysorbate E85, ethoxylated fatty acids, ethoxylated fatty alcohols, ethoxylated and propoxylated fatty acids, ethoxylated and propoxylated fatty alcohols, lecithin, graft acrylic copolymers, and alkyl polyglucoside; and wherein anionic tensioactives are selected from the group consisting of: alkyl benzene sulfonic acid salts, alkyl ether sulfates, alkyl ethoxylated ether sulfates, alkyl polyglycol ether phosphates, alkyl phosphate esters, lignosulfonates, naphthalene sulfonates, ethoxylated tristyrylphenol phosphates, random acrylic copolymers, and combinations thereof; and
an additive selected from the group consisting of preservatives, humectant, wetting agents, spreaders, compatibilizers, binders, fillers, adhesives, protective colloids, thickeners, thixotropic agents, penetrants, retention promoters, sequestrants, clarifiers, anti-freezing agents, anti-caking agents, hydrotropes, stabilizers, antioxidants, UV-light protectors, acidifiers, alkaline agents, chelates, complexing agents, dyes, rheology modifiers, antifoams, anti-drift agents, and combinations thereof, wherein the additive is an antioxidant, preferably the antioxidant is selected from the group consisting of: butyl hydroxyanisole (BHA), butyl hydroxytoluene (BHT), terc-butyl hydroquinone (TBHQ), tocopherols, medium or long chain carboxylic acids, salts of medium or long chain carboxylic acid, propyl galate, nicotinamide, ascorbil palmitate, lignosulfonates, calcium or magnesium carbonate, titanium dioxide, zinc or copper oxide, and combinations thereof; and
water.

18. (canceled)

19. The nematode composition according to claim 17, wherein the carrier is sunflower oil.

20. (canceled)

21. (canceled)

22. The nematode composition according to claim 19, wherein the tensioactives are polysorbate E20, polysorbate E80 and polysorbate E85.

23. (canceled)

24. (canceled)

25. (canceled)

26. (canceled)

27. (canceled)

28. The nematode control composition according to claim 22, wherein
the carotenoid is selected from the group consisting of: beta-carotene dispersed in sunflower oil carrier, astaxanthin dispersed in sunflower oil carrier, lutein dispersed in sunflower oil carrier, lycopene dispersed in sunflower oil carrier, zeaxanthin dispersed in sunflower oil carrier, and/or apocarotenal dispersed in sunflower oil carrier;
the tensioactives which consist of polysorbate E20, polysorbate E80 and polysorbate E85;
the dispersant is butyl glycol;
the antioxidant is TBHQ; and
water.

29. The nematode control composition according to claim 22, wherein
the carotenoid is selected from the group consisting of: beta-carotene dispersed in sunflower oil carrier, astaxantin dispersed in sunflower oil carrier, lutein dispersed in sunflower oil carrier, lycopene dispersed in sunflower oil carrier, zeaxanthin dispersed in sunflower oil carrier, and/or apocarotenal dispersed in sunflower oil carrier;
the tensioactives which consist of polysorbate E20, polysorbate E80 and polysorbate E85; and
the dispersant is butyl glycol,
the antioxidant is TBHQ; and
water.
and wherein:
the sunflower oil is from 2% to 10% (w/w of total composition);
the carotenoid is from 0.1% to 15% (w/w of total composition);
the tensioactives are from 20% to 50% (w/w of total composition);
the dispersant is from 2% to 10% (w/w of total composition);
the antioxidant is from 0.05% to 5% (w/w of total composition); and
water is from is from 0.1% to 60% (w/w of total composition).

30. (canceled)

31. (canceled)

32. (canceled)

33. The nematode control composition according to claim 22, wherein the carotenoid is lycopene dispersed in sunflower oil;
the tensioactives are polysorbate E20, polysorbate E80 and polysorbate E85;
the dispersant is butyl glycol;
the antioxidant is TBHQ; and
water.

34. The nematode control composition according to claim 22, wherein the carotenoid is a mixture of lycopene and lutein dispersed in sunflower oil;
the tensioactives are polysorbate E20, polysorbate E80 and polysorbate E85;
the dispersant is butyl glycol;
the antioxidant is TBHQ; and
water.

35. (canceled)
